(19) United States
(12) Patent Application Publication
(10) Pub. No.: US 2011/0004367 A1
(43) Pub. Date: Jan. 6, 2011

(54) Autonomous water-borne vehicle

(75) Inventors: Jimmy Dale Saunders, Georgetown, TX (US); Timothy Daniel Raymund, Austin, TX (US); Jason Christopher Splawn, Leander, TX (US); Scott William White, Austin, TX (US); Debbie Lee Campbell, Austin, TX (US); Cynthia Gaye Huyser, Austin, TX (US); Petre Rusu, Austin, TX (US); Mark Leo Brucks, Austin, TX (US)

Correspondence Address: Jimmy Saunders, 9601 West Highway 29, Georgetown, TX, 78628, US

(73) Assignee: J3S, Inc.

(21) Appl. No.: 12/807,665

(22) Filed: Sep. 10, 2010

Related U.S. Application Data
(63) Continuation of application No. 11/710,004, filed on Feb. 24, 2007.
(60) Provisional application No. 60/778,172, filed on Feb. 28, 2006.

(51) Int. Cl. G05D 1/00; B63B 27/08

(52) U.S. Cl. 701/23; 114/268

(57) ABSTRACT

The technical disclosure herein describes an autonomous water-borne vehicle having a segmented non-planing hull with free flood fore and aft sections and a sealed center section. The disclosure also described such a vehicle having a fixed longitudinal thruster and a fixed lateral thruster for changing the heading of the vehicle. The disclosure also described such a vehicle having an autonomous mission system, an autonomous navigation system, and a web-based command and control system. The disclosure also describes such a vehicle having a submersible winch. The disclosure also describes such a vehicle wherein the sealed center section is of substantially rectangular cross section. The disclosure also describes such a vehicle having a wheeled battery tray.

This application claims the benefit of Provisional Patent Application No. 60/778,172, filed Feb. 28, 2006 under 35 U.S.C. 119(e) and Utility patent application Ser. No. 11/710,004 filed Feb. 24, 2007 under 37 U.S.C. 1.53(b).

### 1. BACKGROUND OF THE INVENTION

### 1.1. Hull Configuration

A portion of the present invention relates to vessel hulls. More particularly, this portion relates to autonomous water-borne vehicle (AWV) hulls that have modular components and a minimum number of moving parts.

Some AWV designs use existing hull configurations for manned vehicles. This approach reduces the vehicle cost by reducing design costs, but constrains the design to adapt to an existing hull configuration, often yielding undesirable configurations of equipment and sensors. The existing hull configuration may also include a large number of moving parts based on an assumed crew; this may prove unsuitable for unmanned operations without ready local maintenance.

Other AWV hulls rely on custom hull configurations. Though the custom hull yields an optimal design in terms of equipment, sensors, moving parts, and/or hydrodynamics, the associated manufacturing costs are quite large compared with the use of existing hull configurations.

Therefore, there is a need for an AWV hull configuration that provides customizable equipment configuration, acceptable hydrodynamics, low cost manufacturing, and requires little or no maintenance.

### 1.2. Steering and Propulsion

A portion of the present invention relates to the steering and propulsion of an autonomous water-borne vehicle (AWV) using a minimum of exposed moving parts for thrust and steering.

In a traditional water-borne vessel, propulsion and steering is typically implemented using an in-board or out-board motor and a rudder or moveable thruster mounting. These approaches provide responsive performance, both in terms of acceleration, top speed and maneuverability. These approaches also lend themselves to cases where the vessels are manned, as monitoring and minor maintenance take place in a timely manner, maintaining high availability of steering and propulsion functions. Fouling and grounding is avoided where possible and resolved quickly when encountered. These approaches work particularly well in deep open water and in well cleared channels and harbors where fouling and grounding is unlikely.

In the case of an AWV, the desired/required peak performance may be somewhat lower than that desired/required of a traditional water-borne vessel. The performance may also be limited by constraints on desired/required stored energy capacity and maximum endurance. This may be true of both thrust and maneuverability. In addition, an unmanned, remote AWV may be disabled and lost to a fouled propeller or broken shaft or control mechanism. Though an AWV may be used in the open ocean or a clear harbor, many AWV applications involve navigating waters impassible to normal surface vessels, for example, underneath a dock or bridge. Finally, the AWV design and maintenance may be constrained by cost to a minimum, motivating a limited number of exposed components. This may motivate a design that does not include a hull-penetrating shaft, external rudder or moving thruster for propulsion and steering.

Therefore, there is a need for simple steering and propulsion systems that use a minimum number of exposed moving parts while providing acceptable thrust and maneuverability to the AWV.

### 1.3. Autonomous Navigation Systems

A portion of the present invention relates to navigation algorithms. More particularly, this portion relates to autonomous navigation of surface vehicles that carry sensors required to efficiently transit to and operate at specific locations and/or on specific headings.

One traditional approach to deploying ocean sensors is to deploy them manually and leave them in place, for example by attaching them to a moored buoy or dropping them from aircraft. In this approach, the sensor positions and orientations are either fixed or at the mercy of external forces, limiting the value of some sensor data and/or requiring redundant sensors to achieve full coverage. This is particularly true for electro-optical sensors (radar, video, photographic) where shifts over time in the field of interest may make a fixed mount no more useful than one with random variations in heading. As is commonly known, even platforms with multiple moorings in relatively calm seas exhibit substantial yaw due to currents and wind. For acoustic sensors, a fixed deployment may prove sub-optimal as the monitored field or event evolves and critical sound sources move away from the moored sensor. A drifting deployment may also prove similarly unsuitable. In addition, the cost of deployment may be prohibitive, particularly if an aircraft is required.

Another approach is to attach the sensors to a manned vessel or to a person and move the sensors through the field of interest or position them near the event of interest. In this approach, the cost of collecting data may be relatively high as manual labor and a dedicated vessel are involved. The approach may not provide repeatable surveys of the area, depending on the navigation accuracy of the person carrying the sensor or the vessel. This approach may also involve substantial risk to a vessel and even unacceptable levels of personal risk depending on the field or event of interest.

Therefore, there is a need for accurate autonomous navigation algorithms that efficiently and automatically navigate (unmanned) a sensor heading water-borne vehicle from point to point, station keep at a point and/or maintain a constant heading.

### 1.4. Web-based Command and Control

A portion of the present invention relates to the command and control of an AWV. More particularly, the invention relates to remote command, control and monitoring of an AWV (or group of vehicles) that carry payloads, that can include sensors.

Traditional remote control systems host command, control and monitoring functions at the command and control system. This typically requires the development and implementation of functional modules, a communications protocol, and a well defined interface between the command and control station and the remote vehicle system. Typically, this constrains the implementation of command and control to the exact realization of these functions as they are worked out from the design; that is, the command and control system is fixed to specific functions operating on a particular platform using particular (often custom) communications protocols and a particular communications link.

This approach increases the cost of designing, implementing and maintaining the command and control system, and limits re-implementation of the design for varied capabilities. For example, the communications protocols are often inextricably linked with the communications link hardware; if new a new range or data rate is desired/required, motivating the selection of different link hardware, the existing implementation cannot be reused. If the command and control system becomes unavailable, an exact replica must be obtained for continued operations.

Therefore, there is a need for a lower cost, platform-independent command and control system that conforms to an industry standard communications protocol and link method; that is, a command and control system that may be implemented using a variety of platforms, software and link hardware as long as the selected items adhere to standard communications protocols and link methods.

### 1.5. Submerged Winch for Deploying Electronics Payloads

A portion of the present invention relates to vertically deploying payloads. More particularly, this portion relates to autonomously deploying electronics payloads vertically from an AWV.

Traditionally electronics payloads deployed vertically into water are deployed manually from a dry area. For example, conductivity-temperature-depth (CTD) sensors that measure water conductivity, temperature and pressure, are typically deployed from the deck of a ship, a dock or a barge. Connections and deployment are handled manually or by a dry winch or crane. The cable for such a payload may contain multiple conductors, but it is often relatively light cable as the payload typically creates little strain on the cable and the cable itself is of neutral or slightly positive buoyancy.

In the case of an AWV, there is little or no “deck” guaranteed to be dry. The limited energy storage capacity of an AWV motivates a low water line and minimum exposed surface. In addition, AWV stability may be adversely affected if motors and drums of cable are mounted much above the center of buoyancy.

At the same time, the winch must be operated unmanned on the vehicle. This may mean that the vehicle must operate the winch autonomously; that is, the AWV may have to operate the winch without manual monitoring or intervention.

Therefore, there is a need for an autonomous winch that can be mounted at or below the center of buoyancy (submerged) that deploys electronics payloads to selected depths.

### 1.6. Payloads

A portion of the present invention relates to autonomously deploying a wide variety of payloads with little or no required modification to the deploying vehicle. More particularly, this portion relates to autonomously deploying payloads vertically from an AWV.

Traditional platforms for ocean sensors are developed specifically for the payload or payloads they carry. A new payload often requires a new platform design. This can be attributed to the relatively limited functional capabilities of many electronic components available in the not too distant past, particularly computational, analog-to-digital conversion, and storage components. As the functional capability of more recent electronics components increases and costs continue to fall, it becomes more cost effective to develop a more flexible system capable of carrying a wider variety and number of payloads. In addition, budget pressures, environmental concerns and personnel safety issues have motivated a move towards autonomous platforms that can effectively perform repetitive and potentially dangerous missions at relatively low cost and risk.

Therefore, there is a need for an autonomous sensor platform capable of carrying a wide variety, and large number and configuration of sensors.

### 2. SUMMARY OF THE INVENTION

The present invention is an autonomous water-borne vehicle system consisting of: a segmented hull design; a fixed thruster steering and propulsion design; an autonomous navigation system; a web-based command and control system; and a submerged winch for deploying electronics payloads.

### 2.1. Hull Configuration

The present invention includes a segmented hull design with fore, aft, and center sections. The center section is sealed while the fore and aft sections can be free-flood. The sealed center section is constructed with a permanently sealed front bulkhead and a removable aft bulkhead. This allows concentration of the components that must remain dry in the sealed center section with a minimum of watertight penetrations of the hull.

The center section of the hull has a rectangular cross section allowing for the use of commercial off the shelf internal components in a space efficient arrangement. The batteries and electronics are mounted on removable racks allowing simplified construction and servicing. The mounting of batteries or other energy storage devices on a movable rack allows the batteries to be used as ballast by adjusting the position of the battery tray within the center section.

The hull is also of a non-planing design to allow efficient operation at low speeds typical of autonomous vehicles and easy modification of the payload or endurance capacity of the vehicle by lengthening the center section.

### 2.2. Steering and Propulsion

The present invention includes a steering and propulsion system with a minimal number of moving parts through the use of fixed thrusters. Each thruster requires only a single watertight cable connection and no hull penetrating shafts or other complex watertight hull penetrations. This minimizes the number of watertight hull penetrations and reduces the complexity of the remaining penetrations for increased watertight reliability.

The fixed thrusters can be arranged to provide steering and propulsion through differential thrust, such as when the thrusters are arranged in parallel. Alternatively the thrusters are arranged orthogonal to each other such that those mounted in one direction provide primary thrust and those mounted in the other direction provide steering control.

### 2.3. Autonomous Navigation Systems

The present invention includes an autonomous navigation system providing navigational control over the vehicle. The autonomous navigation system provides transit, constant heading, station keeping, and combined constant heading and station keeping modes.

In the transit mode, the navigation system receives the required location or position that the vehicle is to achieve. This position, referenced to a standard grid, defines an absolute location on the surface of the Earth. The navigation system also receives the required speed and heading (velocity vector) that it is to use to achieve the required position. The navigation system operates a simple feedback loop adjusting propulsion and steering controls based on the error between the actual (current) position and velocity vector and the commanded position and velocity vector of the vehicle. The autonomous navigation system can also incorporate estimated drift forces in addition to the error between actual and commanded position and velocity vectors when determining the thrust commands.

In the constant heading mode the navigation system receives a command to maintain a specific heading or a heading within a desired range (the commanded heading). The navigation system then takes as inputs actual position and heading data and adjusts the propulsion and steering using a feedback loop and the error between actual and commanded headings.

In the station keeping mode the navigation system receives a command to maintain a position (the commanded position). The navigation system takes as inputs actual position and heading data and maintains a state vector of position, heading and speed. The navigation system then adjusts the propulsion and steering using a feedback loop based on the error between the actual and commanded position and the estimated and desired velocity vector of the vehicle to achieve the commanded position. The feedback loop can also be limited in a variety of ways by a location-based hysteresis loop and inner and outer watch circles centered on the commanded position. The limitations allow an operator to trade stored energy against time averaged position error, or in other words, to trade endurance against how tightly the vehicle keeps station.

In the combined constant heading and station keeping method the navigation system receives a command to maintain a constant heading and constant position. Using methods like those described above the navigation system controls the propulsion and steering to obtain the desired heading and position. If the error in heading is larger than the error in position, the propulsion and steering commands are dominated by heading commands. If the error in position is larger than the error in heading, the propulsion and steering commands are dominated by position commands. The algorithm switches smoothly between constant heading and station keeping methods as one error or the other begins to dominate.

The navigation system can also make use of an intelligent motor controller to direct the power feeding each thruster. The use of an intelligent motor controller simplifies the design and reduces the computational complexity of the navigation system by dividing the computational load and simplifying the commands generated by the navigation algorithms.

The navigation system can also provide general navigation by receiving a mission file that contains a variety of navigational commands that may incorporate all of the modes of operation of the navigation system at different times. This reduces the operator intervention requirements and allows the vehicle to complete a mission completely autonomously.

### 2.4. Web-based Command and Control

The present invention includes a web-based command and control system. In this system the vehicle runs a web server on the on-board computer. A standard tele-communications protocol, internet protocol (TCP/IP) network links the vehicle to a command and control station. The command and control station operates a browser that browses the vehicle web server. The vehicle web server provides access to vehicle command and control, vehicle status and mission status. The interaction between the browser and the vehicle web server uses standard web protocols. Any standard internet browser may be deployed on the command and control station. Updating the interface to include new vehicle data products (for example, a graph of internal temperature versus time) only requires updates to the vehicle-served web pages.

### 2.5. Submerged Winch for Deploying Electronics Payloads

A portion of the present invention includes a submerged winch for deploying electronics payloads. The submerged winch includes a sealed motor, an axle, and a spool or drum for holding and deploying/retrieving electronics cable connected to the payload. A slip ring is used to connect the spooled cable to the fixed cable connected to the fixed electronics on the vehicle. An optical encoder can also be used to allow tracking of the length of cable deployed. This enables autonomous operation of the winch to deploy payloads to specified depths, and retrieve the payload on command. A Hall effect switch can also be used to limit winch operation at the ends of the cable.

### 3. BRIEF DESCRIPTION OF THE DRAWINGS

FIG. 1 is a simplified diagram of a vessel according to an embodiment of the present invention.

FIG. 2 is a drawing of an example nose fairing design of the vessel of the present invention.

FIG. 3 is a drawing of an example nose fairing design of the vessel of the present invention.

FIG. 4 is a drawing of an example nose fairing design of the vessel of the present invention.

FIG. 5 is a drawing of an example aft fairing design of the vessel of the present invention.

FIG. 6 is a drawing of example aft fairing design of the vessel of the present invention.

FIG. 7 is a drawing of the internal electronics and battery trays of various embodiments of the vessel of the present invention.

FIG. 8 is a drawing of the internal battery tray of various embodiments of the vessel of the present invention.

FIG. 9 is a drawing of the internal electronics tray of various embodiments of the vessel of the present invention.

FIG. 10 is a drawing of the U-shaped hull ribs of various embodiments of the vessel of the present invention.

FIG. 11 is a drawing of the antenna mounts of various embodiments of the vessel of the present invention.

FIG. 12 is a drawing of the center section lift assembly of various embodiments of the vessel of the present invention.

FIG. 13 is a drawing of the forward tow point of various embodiments of the vessel of the present invention.

FIG. 14 is a drawing of the transit navigation algorithm of various embodiments of the vessel of the present invention.

FIG. 15 is a drawing of the constant heading navigation algorithm of various embodiments of the vessel of the present invention.

FIG. 16 is a drawing of the station keeping algorithm of various embodiments of the vessel of the present invention.

FIG. 17 is a drawing of the motor control algorithm of various embodiments of the vessel of the present invention.

FIG. 18 is a drawing of the mission algorithm of various embodiments of the vessel of the present invention.

FIG. 19 is a drawing of the operator/vehicle algorithm of various embodiments of the vessel of the present invention.

FIG. 20 is a drawing of the motorized winch assembly of the various embodiments of the vessel of the present invention.

### 4. DETAILED DESCRIPTION OF PREFERRED EMBODIMENTS

### 4.1. Hull Configuration

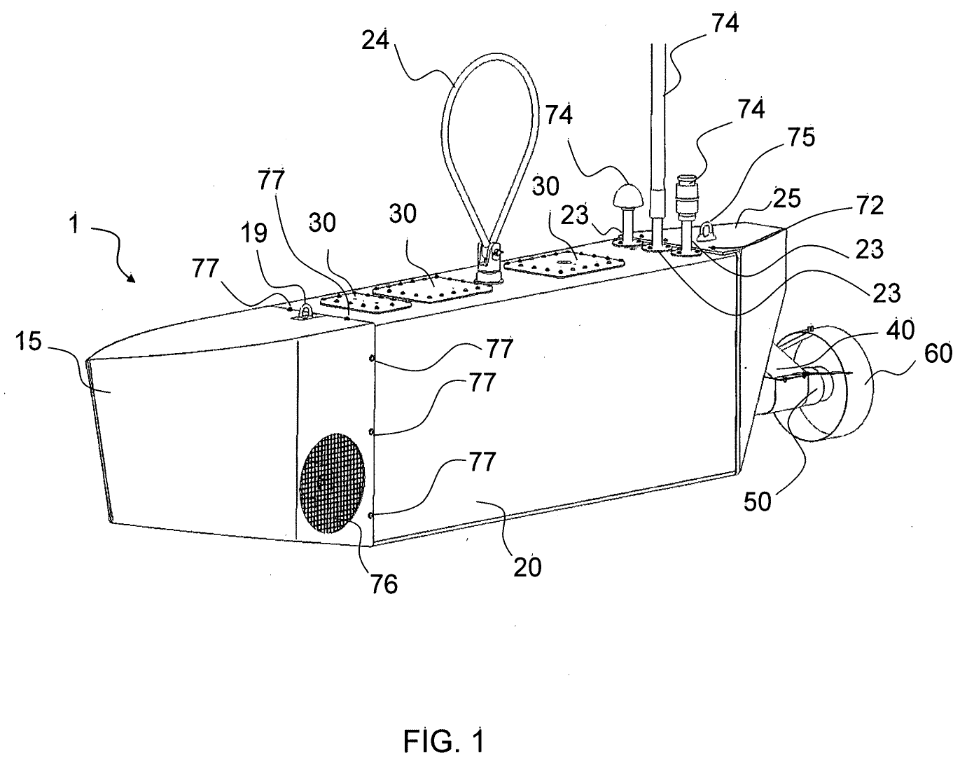

FIG. 1. is a diagram of a vessel 1 according to an embodiment of the present invention. The vessel is made up of hull segments including a free-flood nose fairing 15, a sealed center section 20 and a free-flood aft fairing 25. An aft thruster 50, mounted on a thruster mounting 40 and using a thruster fairing 60, provides forward thrust. The bow thruster tunnel 76 holds a forward thruster that provides steering. Bolt holes 77 at the forward bulkhead of the sealed center section accept bolts fastening the nose fairing to the center section. Bolt holes 72 at the aft bulkhead of the sealed center section accept bolts fastening the aft fairing to the center section. Removable water tight ports 30 provide access into the sealed center section. A lift ring 24 provides a single point for lifting the entire vessel. A tow point 19 at the forward end provides a single point for towing the vessel. A tie point 75 at the aft end provides a point for guiding the vessel with a line during lifts. Antennas 74 are mounted on water tight penetrations 23 near the aft of the sealed center section.

4.1.1. Hull Segments

The vessel hull consists of three segments: a free-flood nose fairing 15, a sealed center section 20 and a free-flood aft fairing 25. The center section, a tube with rectangular cross section, includes a removable, watertight bulkhead on the aft end as well as several removable, watertight ports 30 on the top surface. In the preferred embodiment, the front bulkhead is permanently sealed shut as part of the manufacturing process. Separating the nose fairing and aft fairing from the central section reduces complex sealed surfaces (gaskets and water tight penetrations) in the watertight portion of the vehicle. In particular, this simplifies the design of the center section aft bulkhead, considerably improving the reliability of the bulkhead seal and reducing the cost of manufacturing the center section of the hull.

This embodiment also reduces the likelihood of a collision or other impact causing a hull penetration to leak. Because the nose and aft fairings and their attachment points need not be water tight, the fairings use relatively thin materials that deform on impact, absorbing any impact energy. This also reduces the complexity and cost of the fairing design, manufacturing and maintenance.

4.1.1.1. Nose Fairing

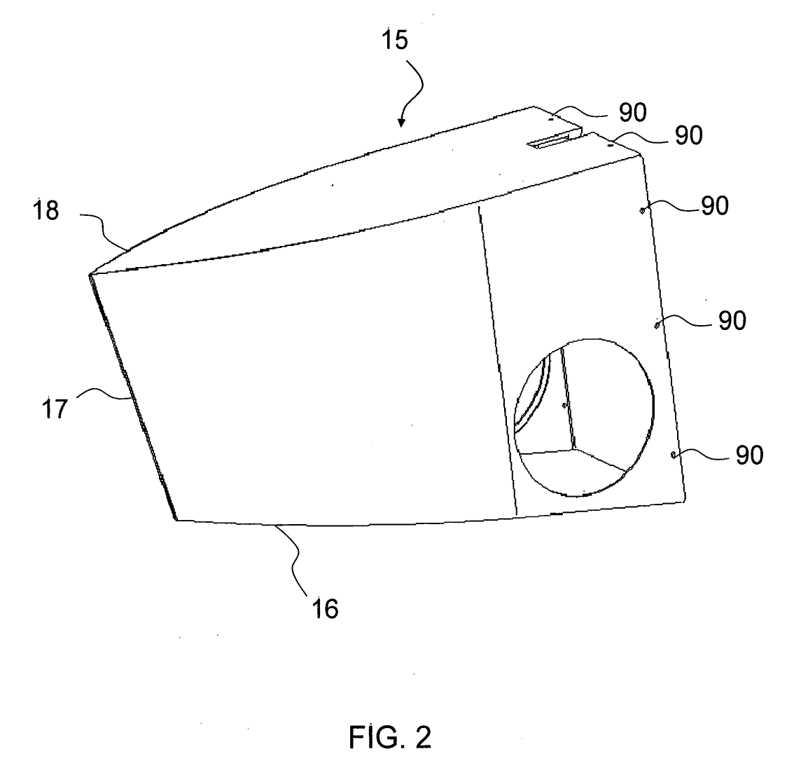

According to one embodiment, the nose fairing 15 would form a sharp bow with lift 16, rake 17 and bow angle 18 as shown in FIG. 2. The lift is the triangular or trapezoidal shape of the cross-section of the nose fairing where the sides slope inward from top to bottom causing the bottom side to be narrower than the top side. The rake is a slant inwards in the forward vertical edge of the nose fairing. The edge begins at the top front of the nose fairing and slants towards the forward bulkhead as the edge progresses towards the bottom of the nose fairing. The bow angle defines the angle on top surface of the nose fairing where the front point is the vertex of the angle and the side edges of the top form two rays intersecting at the vertex. The aft end of the nose fairing is open. The nose fairing slips over the sealed center forward bulkhead and is attached to the bulkhead.

The fairing may be attached using bolts inserted through pre-drilled holes 90 in the faring and screwed into inserts inserted in the bulkhead. The fairing may also be attached by sliding the fairing onto the bulkhead over lugs protruding from the bulkhead. As the fairing is slid onto the bulkhead, the lugs protrude through holes in the fairing. Nuts are threaded onto the lugs and tightened to secure the fairing. The fairing may also be attached by welding the fairing in place to the bulkhead, or by gluing the fairing in place.

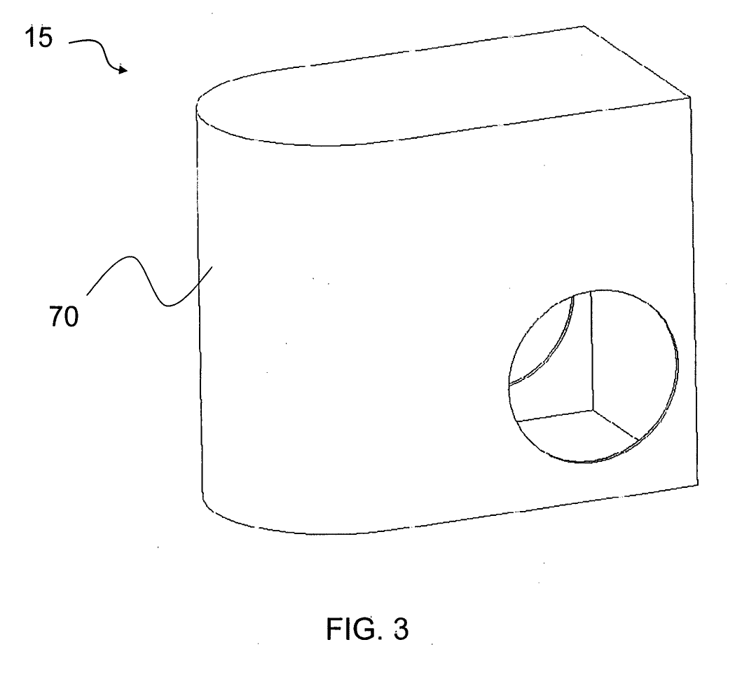

In the preferred embodiment, the forward edge of the center section forward bulkhead is recessed; that is, the bulkhead is slightly smaller than the rest of the center section in cross section. The nose fairing slips over this recessed edge. The edge is recessed to a point where the additional material of the nose fairing slipped over the bulkhead forms a smooth, continuous external surface. Bolts are inserted through holes drilled in the fairing and threaded into inserts inserted in the bulkhead. According to another embodiment, the nose fairing 15 forms a smooth rounded shape with some uniform radius of curvature in vertical dimension 70 as shown in FIG. 3.

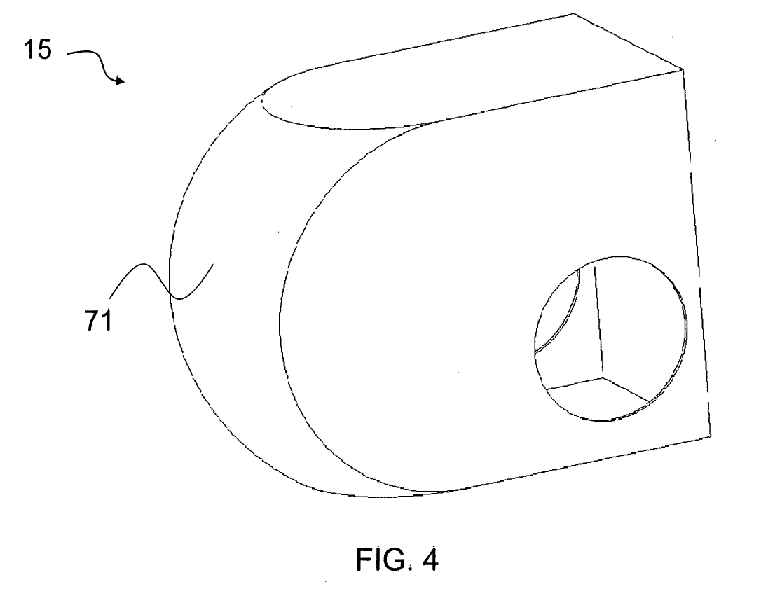

According to another embodiment, the nose fairing 15 forms a smooth rounded shape with a uniform radius of curvature in both vertical and horizontal dimensions 71 shown in FIG. 4.

4.1.1.2. Aft Fairing

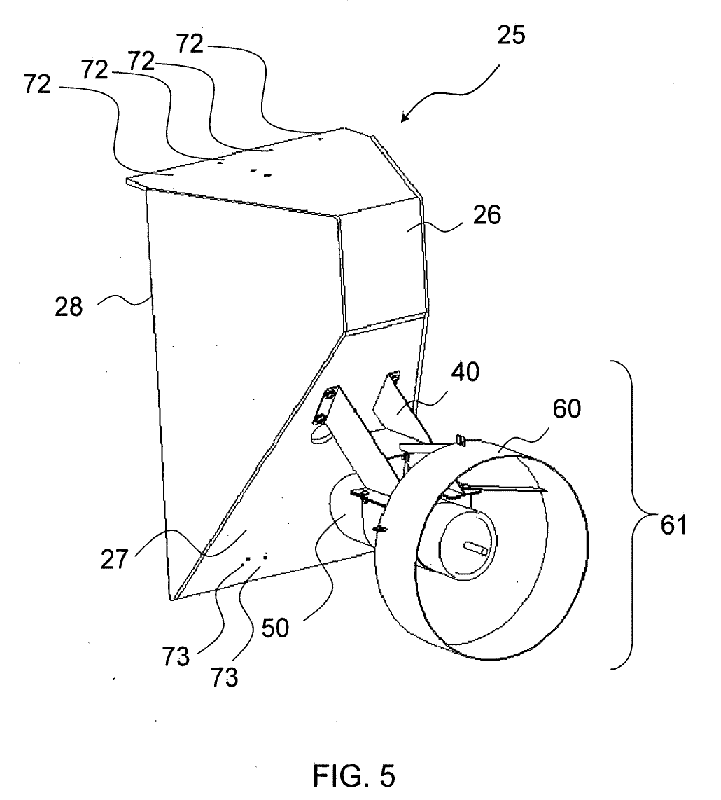

According to one embodiment, the aft fairing 25 forms a box with the width of the box narrowing towards the aft end 26, and the bottom surface 27 radically sloping up towards the aft, as shown in FIG. 5. The forward part of the box 28 is open. The aft fairing supports the fixed mount 40 for the aft thruster or thrusters 50 and shroud or shrouds 60. The aft fairing is attached to the sealed section aft bulkhead.

The fairing may be attached using bolts inserted through pre-drilled holes in the faring and screwed into inserts inserted in the bulkhead. The fairing may also be attached by sliding the fairing onto the bulkhead over lugs protruding from the bulkhead. As the fairing is slid onto the bulkhead, the lugs protrude through holes in the fairing. Nuts are threaded onto the lugs and tightened to secure the fairing. The fairing may also be attached by welding the fairing in place to the bulkhead, or by gluing the fairing in place.

In the preferred embodiment, the aft bulkhead incorporates a narrow lip protruding aft along the top edge of the bulkhead. The aft fairing is slipped onto the aft end of the center section over this lip. Bolts are inserted through holes 72 in the top of the fairing and threaded into inserts inserted in the lip. On the sloping surface of the aft fairing, near where the bottom of the fairing meets the aft bulkhead, additional holes 73 are drilled through the lower part of the aft fairing. Bolts are also inserted through these holes and threaded into inserts inserted in the aft bulkhead. This approach results in a secure attachment of the aft fairing 25 and aft thruster assembly 61 to the aft bulkhead.

The shape offers structural support for the aft thruster or thrusters, provides a hydrodynamically efficient aft shape, and reduces the labor and materials costs of manufacturing as compared with more complex shapes.

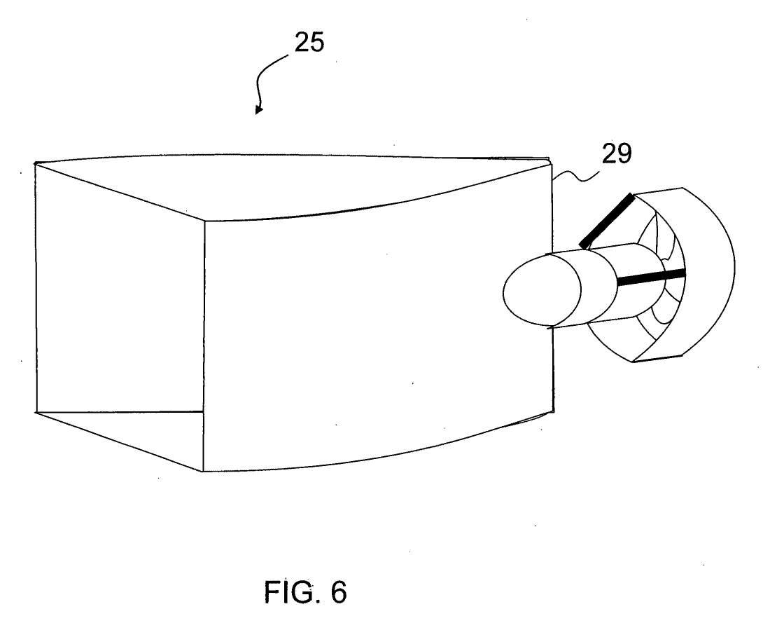

According to another embodiment, the aft fairing 25 method forms a smoothly closing aft end with a sharply increasing radius of curvature smoothly gradated to a sharp point in the vertical dimension 29 as shown in FIG. 6.

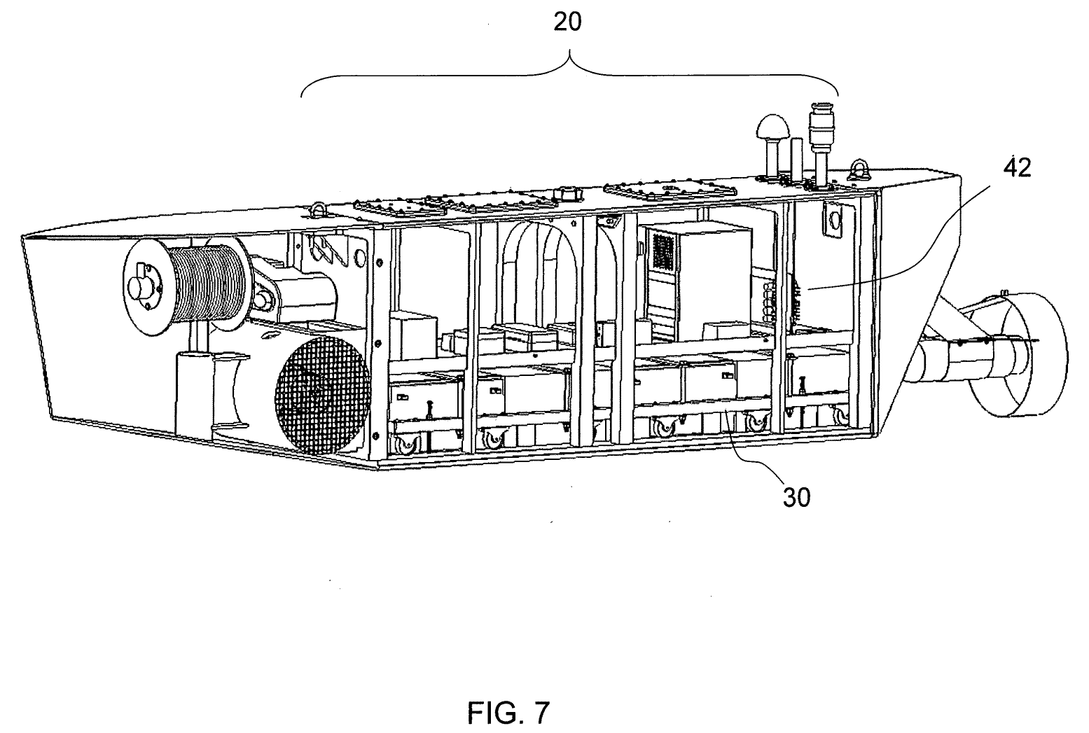

4.1.1.3. Sealed Center Section The sealed center section 20 contains all of the components that must remain dry to operate as shown in FIG. 7. This includes the battery assembly 30 and the electronics assembly 40 that operates the vehicle and the payload.

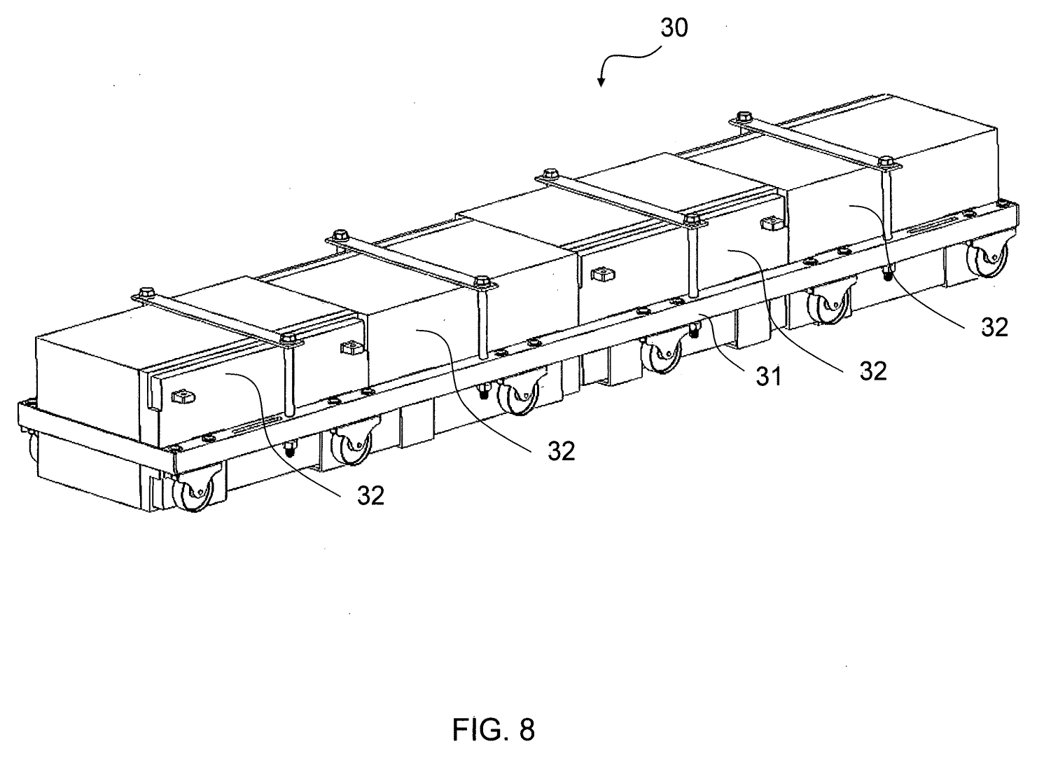

With the aft bulkhead open, the batteries slide in and out of the ONAV sealed center section on a wheeled tray 31 as shown in FIG. 8. A single connector block, accessible once the aft end is open, electrically connects the battery assembly 30 to the vehicle. To remove the battery assembly, the operator disconnects the connector block, releases the locking mechanism on the tray, and slides the assembly out of the aft end. Although the operator may charge the batteries 32 in place, the sliding tray allows the operator to quickly substitute a charged battery set for a discharged one, reducing turn around time and maintenance costs. This also reduces manufacturing time and cost over individually installing the batteries inside the hull. The battery tray also simplifies transportation of vehicle assemblies; the batteries, a significant percentage of the overall weight of the vehicle, may be easily separated from the vehicle and transported separately or left behind. The tray 31 offers some structural support, securing the batteries in place and distributing the weight of the batteries evenly across the hull. Finally, adjusting the position of the battery tray inside of the hull provides an easy method of trimming the hull without adding or removing ballast.

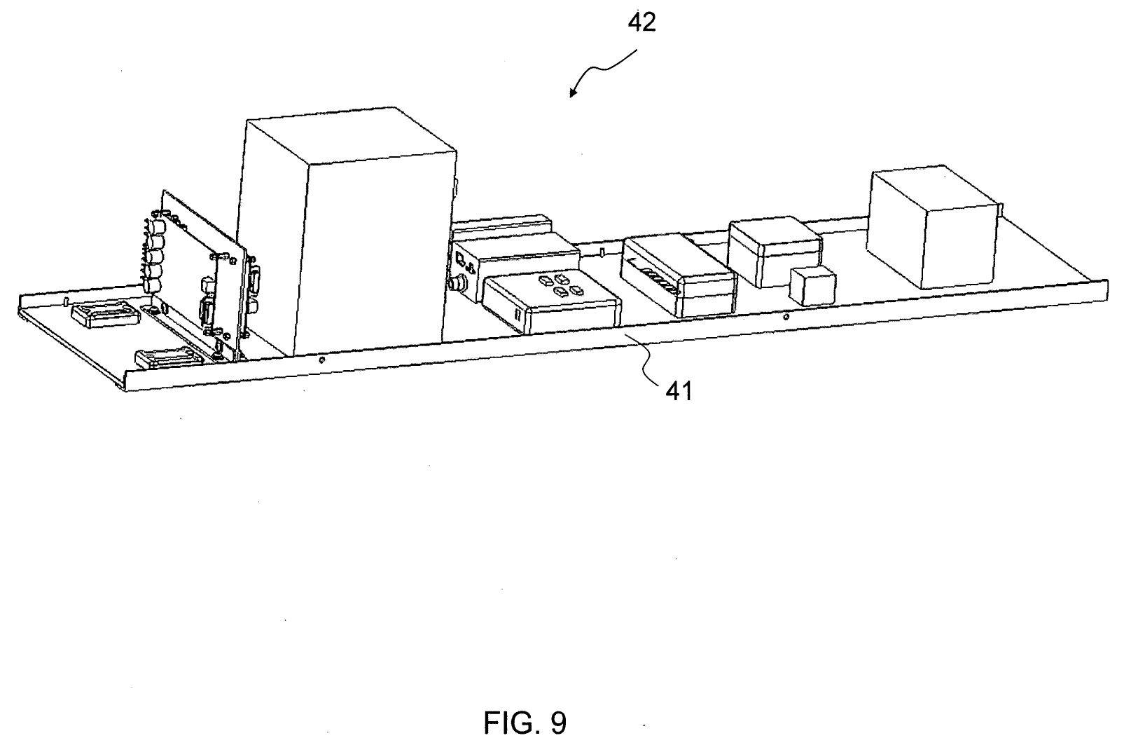

Similarly, an operator may remove the electronics assembly 42 by sliding the electronics tray 41 out of the sealed center section through the open aft bulkhead as shown in FIG. 9. Again, a single connector block, readily accessible once the aft bulkhead is open, connects the electronics to the rest of the system. To remove the electronics assembly, the operator disconnects the connector block, releases the tray locking mechanism and slides out the tray. This significantly reduces the cost of maintenance over a system composed of individual components where an operator must spend considerable time and effort disconnecting and removing items from the vehicle. This also reduces manufacturing costs over individually installing the electronics components inside the hull. This design also provides for flexibility, reducing the cost and complexity of enhancements and new payload integration. To operate a new payload, the operator may substitute an entire tray of pre-cabled and integrated electronics, rather than working inside the vehicle, disconnecting and connecting individual components.

4.1.2. Center Section Structure

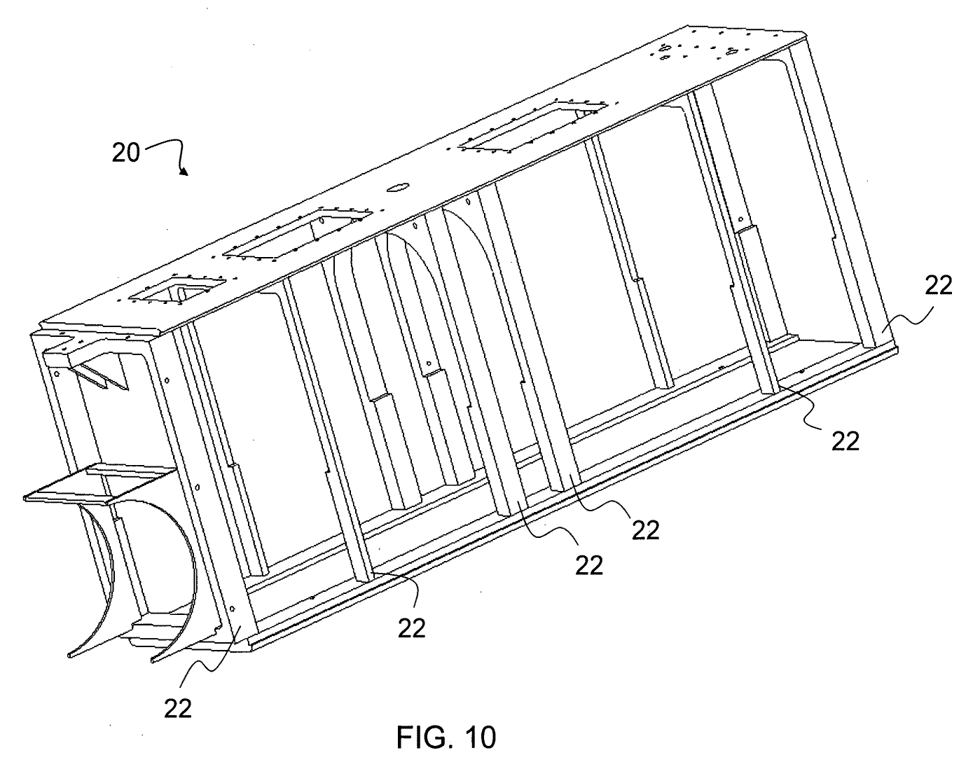

U-shaped hull ribs 22, mounted transverse to the long axis of the sealed center section 20 shown in FIG. 10, reinforce the hull structure and define the cross section of the sealed center section. The ribs 22 are open at the bottom and attach to a thick sheet that forms the bottom of the sealed center section. The sealed center section includes six or more ribs: one at each end, two ribs bracketing a center lift plate at the middle of the center section, and two or more additional ribs spaced between the center ribs and the end ribs.

Combining the ribs with sheet wall materials lowers the overall weight of the vehicle as compared with a solid wall (rib-less) design while maintaining comparable structural integrity. This in turn reduces the overall weight while maintaining displacement, allowing the vehicle to carry additional weight in the same volume. Although adding ribs adds some complexity to manufacturing, it also reduces the required volume of materials.

The resulting rectangular cross section of the center section also reduces manufacturing costs as compared with more complex rounded shapes. Manufacturing more complex shapes requires complex manufacturing drawings, significant manipulation and/or trimming of the material, and complex joints. All three of these requirements raise the cost of manufacturing. In addition, the complex joints are often longer than the ones found on a square design; in a water-tight design, the additional joint length represents a higher probability that the body will leak, particularly if the joints have complex geometry.

The rectangular cross section of the center section also easily accommodates lower cost commercial off-the-shelf (COTS) products used in the electronics assembly. Many COTS assemblies have a rectangular shape; an efficient arrangement of components is easily achieved with the rectangular cross section. For example, commercially available, standard sized batteries fit neatly in the rectangular space.

4.1.3. Materials

In the preferred embodiment, the hull is constructed primarily from sheets of poly vinyl chloride (PVC) plastic that are cut or formed to the desired shapes. Permanent water tight seams are welded together, and bulkheads, portals and other removable segments are fastened together using bolts or other removable fasteners. Other permanent seams (not water tight) may be welded or fastened together.

In another embodiment, the hull is constructed of metal. Permanent water tight seams are welded together and bulkheads, portals and other removable segments are fastened together using bolts or other removable fasteners. Other permanent seams (not water tight) may be welded or fastened together.

In another embodiment, the hull is constructed of plastic formed by injection molding. This is likely the most cost effective approach for manufacturing large quantities.

In another embodiment, the hull is constructed of fiberglass built up on forms of the hull segments. This is likely the most cost effective approach for manufacturing a medium quantity.

In another embodiment, the hull is constructed of wood.

In another embodiment, the parts of the hull are constructed using a variety of the above mentioned materials and construction methods.

4.1.4. Non-Planing Hull

The combination of hull segments creates a non-planing hull; that is, as speed increases, the hull does not lift out of the water. The use of a non-planing hull is consistent with several parameters of the design: navigation in shallow waters, autonomous operations, low cost and stable forward motion. The preferred embodiment uses a smooth, flat bottom, ideal for navigating shallow waters, but ill suited for planing. The preferred embodiment also seeks to conserve on-board battery power, extending the range of the vehicle. Getting up and staying on plane requires roughly ten times the power output required for propulsion at non-planing speeds. The thruster and power control required for high power (planing) propulsion substantially raises the cost of the vehicle. Finally, a planing hull will more easily pitch and roll at low speeds or at rest, where as the hull form associated with a non-planing hull resists pitch and roll forces at slow speeds more effectively.

The preferred embodiment uses a modular hull design to implement a non-planing hull. The flat bottomed center section joined with the nose fairing essentially form the hull. The nose fairing is shaped to provide a stable, non-planing shape that resists diving as speed increases. Because the nose fairing is modular, a variety of nose fairings may be applied depending on the environmental conditions, the payload and the desired hull performance.

4.1.5. Adjustable Trim

As mentioned before, the battery tray may be used to adjust the trim of the vehicle. Changing the battery tray position changes the distribution of weight within the vehicle, which changes the trim of the vehicle. Since the batteries make up a significant percentage of the overall vehicle weight, only minor adjustments of the battery tray can effect large changes in trim. This allows rapid adjustments to trim without dedicated ballast. This is useful in the case of a change in vehicle configuration, for example a payload addition or change, particularly if the change is made in the field.

In the preferred embodiment, the interior of the sealed center section is slightly longer than the battery tray. In one trim adjustment method, the battery tray is fixed to a jack screw bolt. An operator adjusts the forward/aft trim of the vehicle by opening one of the top side access ports and inserting a crank. The crank connects to a universal joint and turns the jack screw, adjusting the battery tray forwards and aft.

In another forward/aft trim adjust method, the battery tray mounts to two parallel jack screws aligned like rail road tracks under the battery tray.

In another method, the operator adjusts the trim by removing the aft bulkhead and applying a crank to the jack screw or screws directly.

In another method, the battery tray mounts to a sliding track and is clamped in place by a levered clamp or clamps. The operator adjusts the trim by removing an access port, releasing the clamp or clamps, moving the battery tray and then re-applying the clamp or clamps to fix the battery tray in place to the rails.

In another method, the battery tray bolts to rails. Holes in the rail allow the selection of a number battery tray positions. The operator adjusts trim by removing the bolts, adjusting the battery tray, and then applying the bolts to new holes.

In another embodiment, the center section is slightly wider than the battery tray. In one trim adjustment method, the battery tray is fixed to a jack screw bolt. An operator adjusts the port/starboard trim of the vehicle by opening one of the top side access ports and inserting a crank. The crank connects to a universal joint and turns the jack screw, adjusting the battery tray port and or starboard.

In another port/starboard trim adjust method, the battery tray mounts to two parallel jack screws aligned like rail road tracks under the battery tray.

In another method, the operator adjusts the trim by removing the aft bulkhead and applying a crank to the jack screw or screws directly.

In another method, the battery tray mounts to a sliding track and is clamped in place by a levered clamp. The operator adjusts the trim by removing an access port, releasing the clamp lever, moving the battery tray and then re-applying the clamp lever to close the clamp onto the battery tray, fixing the rack in place.

In another method, the battery tray bolts to rails. Holes in the rail allow the selection of a number battery tray positions. The operator adjusts trim by removing the bolts, adjusting the battery tray, and then applying the bolts to new holes.

In another embodiment, the center section is both wider and longer than the battery tray. Jack screws, clamps, or bolts may be used to adjust the position of the battery tray to achieve the desired trim.

4.1.6. Antenna Mounts

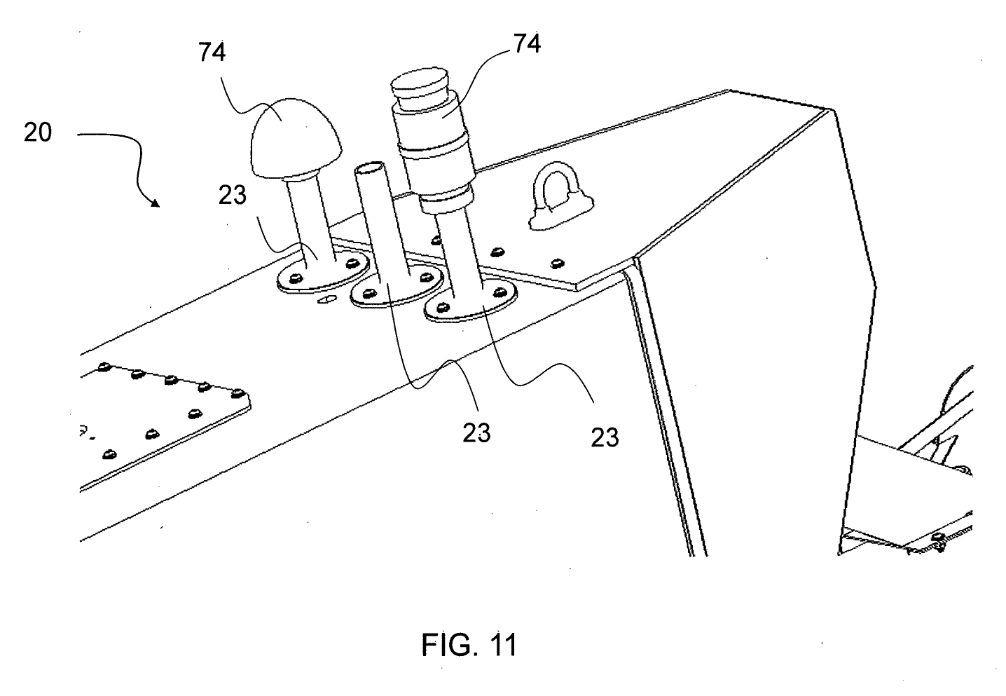

In the preferred embodiment, antennas mount on the top side of the sealed center section 20 as shown in FIG. 11. Cables run through water tight penetrations in the top side and/or through water tight connectors 23, mounted in the top side surface. Mounting antennas 74 on the top side places the antennas as far above the water surface as possible. This reduces the amount of water that the antenna encounters. It also makes mounting the antenna as high as possible easier than a mount on any other surface. Many antennas are recommended to be mounted vertically as the antenna pattern is focused horizontally, affording the best gain for the desired radio link. A top side mount also affords the best view of Global Positioning System (GPS) satellites, yielding the best signal collection for positioning and navigation.

In another embodiment, antennas are mounted in the removable water tight portals. Antenna cables are connected through water tight penetrations in the portal and/or through water tight connectors mounted in the portal. This embodiment enjoys all of the benefits of the preferred embodiment with one addition. The portal-mounted antenna method supports the addition of payload antennas with out requiring significant and/or permanent new penetrations in the hull itself. If a payload is removed or only temporarily applied, an associated antenna may be easily installed in the field with a minimum of tools and time as compared with drilling a new hole in the hull and fitting a new water tight connector into the hull.

4.1.7. Endurance Adjustment

In the preferred embodiment, four or more batteries reside in the battery tray. One battery is used for electronics power and three or more batteries for propulsion. A particular vehicle evolution with repeated or continuous operation of propulsion will eventually exhaust the batteries. An evolution with repeated or continuous operation of the electronics will also eventually exhaust the electronics battery. For the sake of discussion, define endurance as a property of the vehicle; that is, its capability to repeatedly or continuously operate over a time period. To achieve a desired/required endurance, it may be necessary to add more battery capacity. If the desired/required endurance is less than the current capability of the design, a cost savings may be realized by reducing endurance. In the preferred embodiment, endurance of the vehicle is adjusted by adding or removing batteries. In the preferred embodiment, the length of the sealed center section in the axial direction is altered at manufacture to accommodate a longer or shorter bank of batteries. This approach has several advantages.

First, lengthening or shortening the hull in the axial direction does not significantly alter the hydrodynamic properties of the hull. The additional length adds some skin drag and changes the overall mass of the body, but the drag due to cross section, by far the largest component, remains unchanged and additional air space is added at the same rate as additional mass, maintaining the same waterline. The operating modes and characteristics of the vehicle remain the same. This means that no changes are required to the operating algorithms of the vehicle.

Second, the extension or compression of the length may be made quite easily by extension or removal of essentially the same structure: the battery tray, the bottom plate and the sheet forming the side walls. The extension may require additional ribs and lift points; in all other respects, in only requires the lengthening or shortening of existing members. The nose and aft fairings remain the same.

This minimum-change approach to changing endurance reduces design costs and manufacturing costs. In general, changing the length of the hull supports a change in endurance (battery capacity) for payload and/or for propulsion without significant changes to the architecture or significant performance penalties.

For specialized applications other power supply systems may be substituted for batteries, such as fuel cells.

4.1.8. Access to the Sealed Center Section

In the preferred embodiment, the top deck of the center section includes three access ports. The access ports provide limited access to the interior of the vehicle without requiring major disassembly (for example, removal of the aft fairing and the aft bulkhead).

As mentioned, the access ports provide limited access to the interior of the vehicle. For minor adjustments and repairs, this ready access requires less time, tools and effort as compared with removing the aft fairing and the aft bulkhead. This method also allows for minor adjustments and repairs while the vehicle is in the water as the access ports are above the water line. Because removal of the access ports is less complicated than removal of the aft fairing and the aft bulkhead, access by this method reduces the likelihood of introducing a leak, particularly as the access ports are above the water line.

In the preferred embodiment, the access ports are manufactured out of a clear material such as a clear polycarbonate resin. This allows visual inspection of the interior of the sealed center section. Visual inspection may include evaluating the indicator lights on the electronics tray, evaluating interior component placement and stability, and inspecting for water (leaks) in the sealed center section.

As mentioned elsewhere, the access ports may support temporary antennas for additional payloads. This makes changing payloads in the field less expensive as changing access ports does not require the time or tools necessary to add a permanent penetration to the hull and changing an access port takes far less time than opening the aft end of the vehicle. This concept may be extended further to actual payloads. In another embodiment, the access port may have a payload mounted on it, and/or it may support other payload related items such as a camera, weather station or solar panel. In this embodiment, the entire payload is installed or removed by installing or removing the access port.

4.1.9. Lift and Tow Points

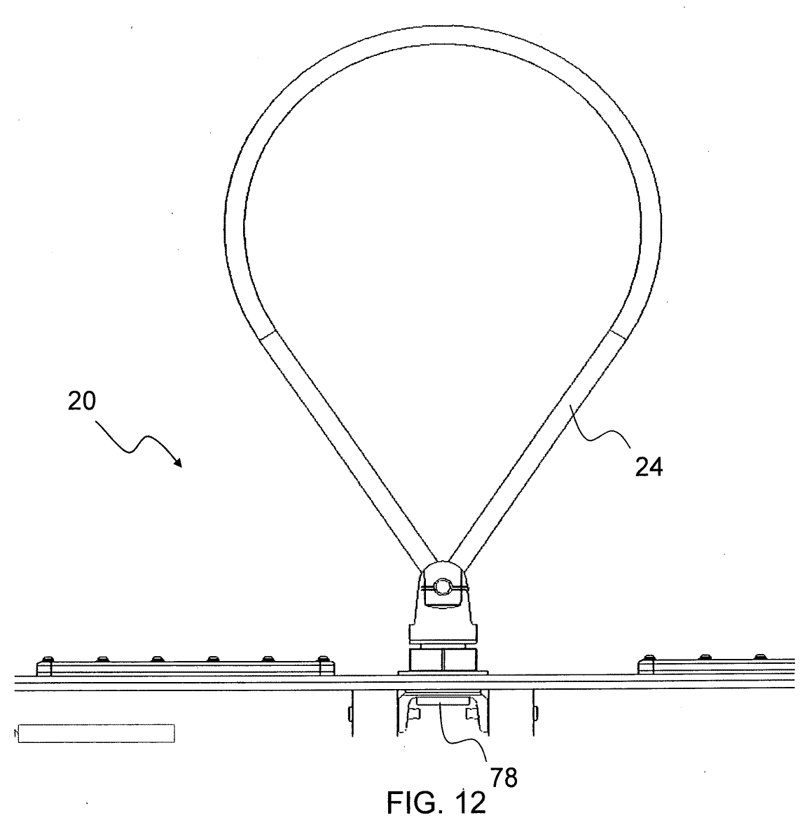

In the preferred embodiment, the sealed center section is lifted by a lift ring located in the middle of the top deck of the sealed center section 20 as shown in FIG. 12. The lift ring 24 is attached to a lift plate 78 located on the underside of the sealed center section top deck. In the preferred embodiment, the lift ring and lift plate are made of metal. The lift ring is attached to the lift plate by a rotating collar. The lift ring provides a single lift point for deployment and recovery of the vehicle with winches, cranes or davits. The ring is easily fixed to lifting device, for example, by hook or strap. The lift plate distributes the load to the hull.

Using a single lift point simplifies deployment and recovery as compared with multiple lift points. Only one lift point needs be rigged and released. The location of the lift point on the center section of the hull also facilitates moving the center section alone, as compared with not having a lift point in the center section.

In another embodiment, the lift ring is replaced with a load latch. This requires that the matching part be used on the crane, winch or davit to attach to the vehicle and lift it. This approach provides a standard means to deploy, release and recover the vehicle that is safer and more secure than ad hoc methods for attaching a lift mechanism to the lifting ring.

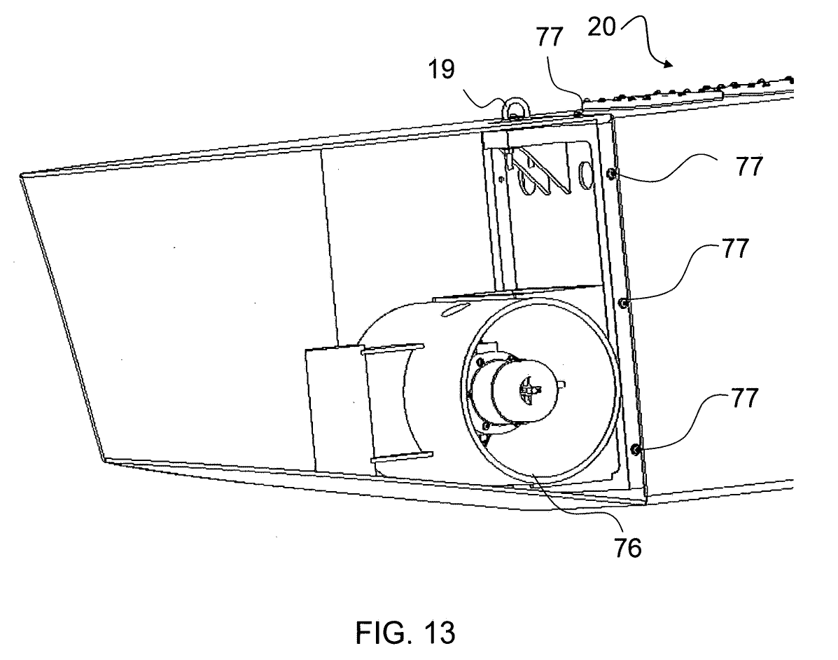

A tow point 19 at the front of the sealed center section 20 as shown in FIG. 13, provides for controlled deployment and recovery with a ramp.

Deployment and recovery with a ramp is simpler and requires fewer resources than deployment with a crane, winch or davit. If a line is connected to the tow point while the body is being lifted by the center lift ring, the tow point provides a means to keep the body stable during the lift.

### 4.2. Steering and Propulsion

4.2.1. Thrusters

In the preferred embodiment, the steering and propulsion components consists of a fixed main thruster mounted at the aft end of the hull and a fixed, transverse-mounted thruster mounted in the bow. Each thruster consists of a fixed mount, a sealed, submersible motor, a compatible propeller, and a sealed cable connecting the motor to a water tight connector on the sealed center section of the hull. The only moving parts are internal to the thruster housings and the propeller and propeller shaft protruding from the thruster housings.

This approach uses fewer components than a conventional design using a hull penetrating shaft, external rudder or movable thruster for propulsion and steering. The reduced number and the fixed nature of submerged, external components, as compared to designs that use external moving parts; improve the reliability of the design. For example, by fixing cable lengths, runs and connector locations, the design reduces the likelihood of a cable fraying, wearing or cracking as compared with a design that uses moving external components. The approach also simplifies the mechanical design significantly as compared with one that uses moving parts. For example, the mechanical design of a fixed motor mount is much simpler than one that requires moving parts, especially if moving parts must penetrate the hull. Finally, the method reduces manufacturing and maintenance costs by reducing the part count and the complexity of the external, submerged assemblies as compared with approaches that use moving parts. The design also requires fewer penetrations of the hull than a design using a penetrating shaft, external rudder or moving thruster. This also improves reliability, simplifies the design and reduces manufacturing costs.

In another embodiment, two motors are mounted behind the vehicle in parallel. Both contribute simultaneously to propulsion and steering by differential thrust control. This approach enjoys all of the same advantages as the preferred embodiment, with three additions.

First, the maximum thrust may be much greater when a straight line transit is desired as compared with the preferred embodiment. With two motors operating in parallel and no turning required, both motors are devoted to forward thrust. Similarly, the design may scale back the thrust of each motor, reducing the size and weight of the thruster assemblies and achieving the same overall forward thrust as the preferred embodiment. This benefit comes at the cost of turning radius; the two parallel motors located at the aft end may not offer as much heading control as the transverse thruster in the preferred embodiment for some applications.

Second the number of assemblies and parts may be reduced. Given that both motors are located at the aft end, a single motor mount may suffice to attach both motors to the hull. This reduces the number of parts as compared with the preferred embodiment.

Third, the drag of the body is reduced as compared with the preferred embodiment as the tunnel necessary for the transverse mounted thruster is removed, smoothing the line of the hull. This also simplifies manufacturing.

In another embodiment, motors are mounted on each side of the vehicle, again in parallel. This approach enjoys all of the same advantages as the preferred embodiment and all of the advantages and caveats as the dual thruster embodiment described above with the following exception.

By placing the motors on the sides of the vehicle instead of directly behind the vehicle, the motors provide greater heading control and improved water flow. While again forcing the design to include two motor mounts, it also removes mounting fixtures from the aft end, permitting the aft fairing to be designed to further optimize flow (reduce drag). Note that this design is more susceptible to fouling and may not be suitable for operations where the waters may be fouled by debris.

4.2.2. Fixed Transverse Mounted Bow Thruster as the Sole Means of Autonomous Heading Control

As mentioned previously, the preferred embodiment uses two fixed thrusters to autonomously achieve propulsion and maneuvering. In the preferred embodiment, a fixed thruster mounts at the aft end of the hull and a fixed, transverse-mounted thruster mounts in the bow. The bow thruster motor operates both forward and reverse, thrusting water in either transverse direction. Operating the bow thruster causes the vehicle to pivot around a point near its center of gravity, changing the vehicle heading. In the preferred embodiment, the bow thruster provides the sole means of heading control.

The bow thruster is mounted on the inside of a transverse tube. In the preferred embodiment, a threaded clamp is inserted through a matching hole in the transverse tube. The clamp is secured to the tube by tightening. The thruster itself incorporates a matching threaded pipe that threads into the clamp. In this arrangement, the thruster is securely fixed in the transverse tube. The transverse tube is mounted to the outside of the sealed center section forward bulkhead. In the preferred embodiment, the tube is welded to the forward bulkhead. Additional side piece sections are added such that when the nose fairing is applied, the spaces between the tube and the forward bulkhead are covered. The nose fairing slips around the bow thruster transverse tube. In the preferred embodiment, screens in the nose fairing cover the ends of the transverse tube, leaving the tube open to water flow while keeping potentially damaging debris away from the bow thruster propeller and motor. A water tight power cable passes through the mated pipe and clamp. The cable is terminated in a water tight connector. This connector is mated with a water tight bulkhead connector placed in center section front bulkhead. The electrical connection is continued from the interior side of the water tight connector in the bulkhead to control electronics and power located inside the sealed center section.

The farther away the location of the bow thruster is from the vehicles center of gravity, the more effective the bow thruster is at altering the vehicle's heading. The preferred embodiment balances distance from the vehicle's center of gravity against the availability of mount points by locating on the forward sealed section bulkhead. The forward bulkhead is the furthest point from the center of gravity with the structure necessary to support the transverse thruster. The location also optimizes drag as compared with other locations. Keeping the transverse tube behind the nose fairing maintains a smooth profile.

As mentioned previously, this approach uses fewer components than an approach using a hull penetrating shaft, external rudder or moving thruster for steering. The reduced number and the fixed nature of submerged, external components, as compared to approaches that use external moving parts, improve the reliability of the resulting design. For example, by fixing cable lengths, runs and connector locations, the approach reduces the likelihood of a cable fraying, wearing or cracking as compared with an approach that uses moving external components. The approach also simplifies the mechanical design significantly as compared with one that uses moving parts. For example, the mechanical design of a fixed motor mount is much simpler than one that requires moving parts, especially if moving parts must penetrate the hull. Finally, the approach reduces manufacturing and maintenance costs by reducing the part count and the complexity of the external, submerged assemblies as compared with approaches that use moving parts. The design also requires no more penetrations of the hull than a design using a penetrating shaft, external rudder or moving thruster. This also improves reliability, simplifies the design and reduces manufacturing costs.

This approach also preserves a smooth line and has less drag than a design that uses an external rudder or an exposed moving thruster. The approach also has less risk of fouling than an approach with more external moving parts and/or parts exposed outside the hull.

This approach is also well suited to controlling heading over a wider range of lower speeds than a system that uses a rudder. In a rudder system, the main propulsion must be engaged to turn the vessel. In this approach, the vehicle may be turned around at very low speeds, even without engaging main propulsion at all.

### 4.3. Autonomous Navigation Systems

This section discusses several methods for navigation control used in the preferred embodiment.

4.3.1. Transit Method

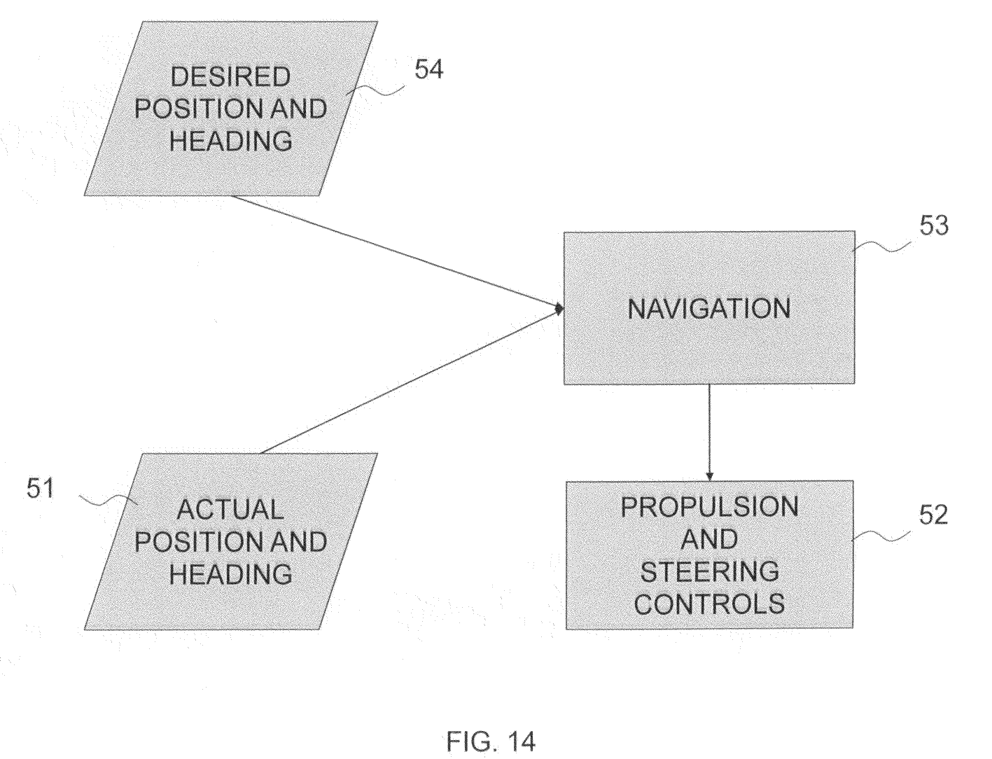

In the preferred embodiment, software running on an on-board processor controlling the vehicle receives a command to transit to a desired position as shown in FIG. 14. The software evaluates actual position and heading data 51, maintaining a state vector of position, heading and speed. In the preferred embodiment, actual position and heading data 51 are collected by the software from an on-board electronic compass and an on-board Global Positioning System (GPS) receiver. The navigation software 53 operates a simple feedback loop, periodically adjusting propulsion and steering controls 52 based on the error between the actual position and heading and the desired position and heading of the vehicle 54. The software controls steering and propulsion by sending thrust commands to an on-board motor controller that feeds power from the batteries to each thruster motor per the commanded thrust.

This approach allows the vehicle to transit autonomously and requires no operator intervention as compared with methods where the operator monitors position and velocity of the vehicle and adjust propulsion and steering accordingly. The approach also remains robust against changing environmental conditions (wind and current) as compared with methods that set a constant heading. The application of this method allows the vehicle to be deployed from a remote location, reducing transit time for the larger (and more expensive) deployment vessel, or supporting deployment from a dock or pier without a requirement for a deployment vessel.

In another embodiment, the vehicle software maintains additional state vector variables for drift forces. The feedback loop incorporates the estimated drift force as well as error terms and develops steering and propulsion thrust commands that correct the error and compensate for the perceived drift force.

The application of this method results in a straight line drive to the desired target point rather than a curved (parabolic) path. This method reduces the time required to make the commanded transit.

4.3.2. Constant Heading Method

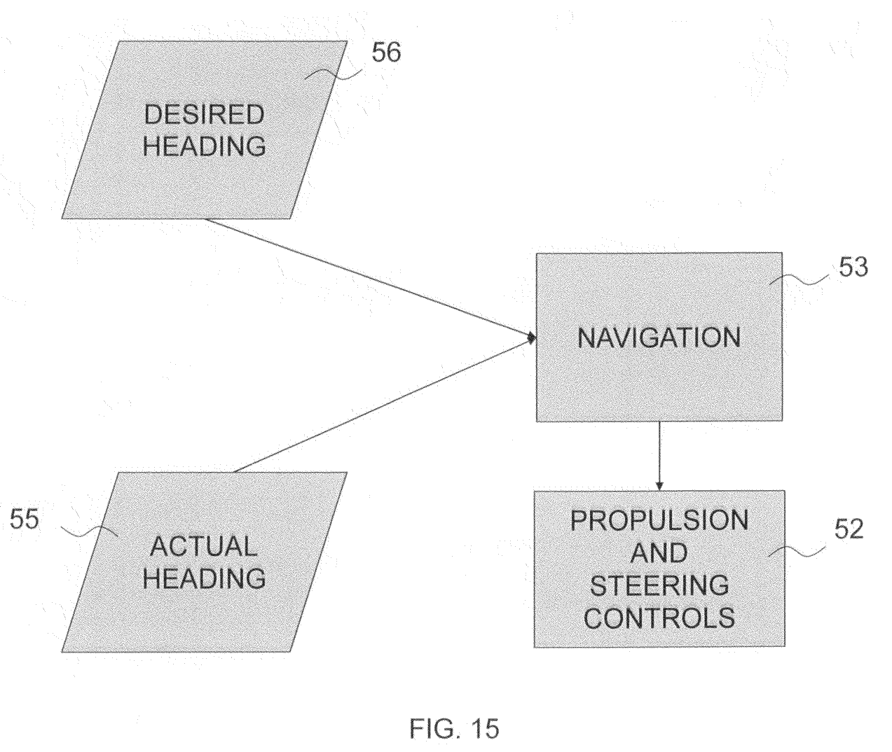

In the preferred embodiment, software running on an on-board processor controlling the vehicle receives a command to maintain a constant heading as shown in FIG. 15. The software evaluates actual heading data 55, maintaining a state vector of position, heading and speed. In the preferred embodiment, position and heading data are collected by the software from an on-board electronic compass and an on-board Global Positioning System (GPS) receiver. The navigation software 53 periodically adjusts propulsion and steering controls 52 using a critically damped feedback loop and the error between the actual and desired headings 56. The software controls steering and propulsion by sending thrust commands to an on-board motor controller that feeds power from the batteries to each thruster motor per the commanded thrust.

In another embodiment, the feedback loop is further limited by an imposed maximum time rate of change of heading. That is, the steering thrust commands are limited as the time rate of change of heading approaches a selected maximum level.

This approach is inherently more stable than approaches that rely only on compass or GPS data because the combination of input data provides enough information to develop a stable model of position, heading and speed, no matter what speed the vehicle moves at. GPS data may provide heading, but only at speeds sufficient to overcome the GPS position error, or over time bases (for averaging) that make the data useless for active autonomous control. Similarly, navigation may be accomplished by dead reckoning; however, without some absolute reference, external forces such as wind and current, will drive the vehicle off course.

The applications for constant heading control include pointing cameras, video recorders, radar and other directional antenna, including antenna for communications or collection. Applications may also include orienting a reflector, collector or target panel, or orienting a release or retrieval mechanism, or maintaining a heading against the force of wind or current, or maintaining a heading to provide a minimum profile to a particular direction.

4.3.3. Station Keeping Method

In the preferred embodiment, software running on an on-board processor controlling the vehicle receives a command to maintain a constant position. The software evaluates actual position and heading data, maintaining a state vector of position, heading and speed. In the preferred embodiment, position and heading data are collected by the software from an on-board electronic compass and an on-board Global Positioning System (GPS) receiver. The software operates a simple feedback loop, periodically adjusting propulsion and steering controls based on the error between the actual and commanded position and the estimated and desired velocity vector of the vehicle. The software controls steering and propulsion by sending thrust commands to an on-board motor controller that feeds power from the batteries to each thruster motor per the commanded thrust.

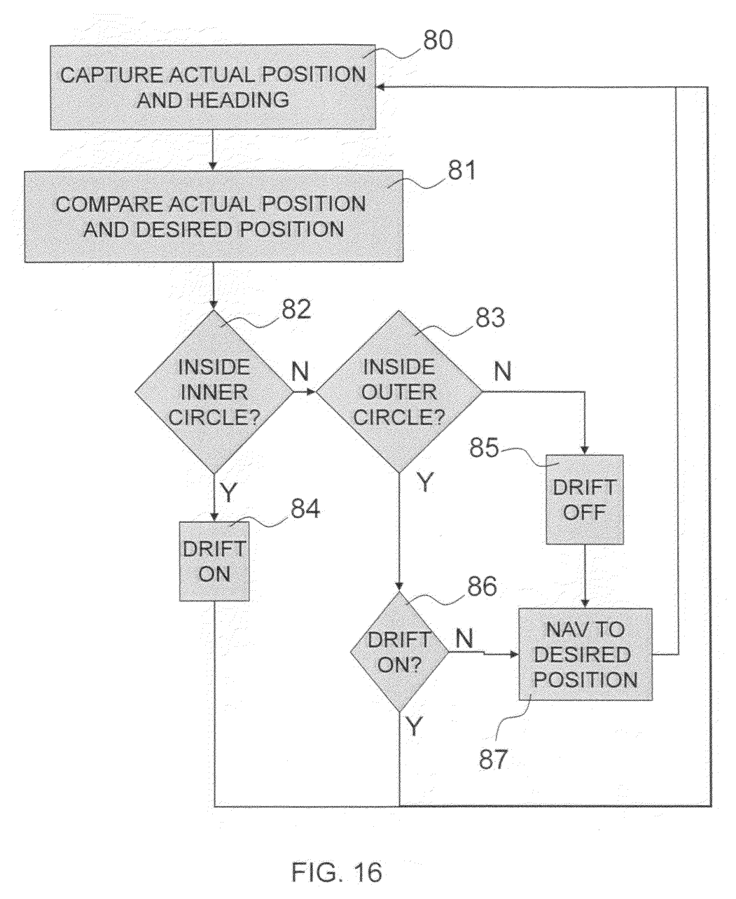

In the preferred embodiment, the feedback loop is further limited by a location-based hysteresis loop and inner and outer watch circles centered on the desired position as shown in FIG. 16. The software first acquires position and heading data 80 and then compares those data with the desired position 81. If the actual position is inside of the inner watch circle 82, then the software turns drift on 84 and restarts the loop.

If the actual position is on or outside of the inner watch circle, then if the actual position is inside the outer watch circle 83, the software tests drift 86. If drift is on, the software restarts the loop. If drift is off, the software navigates 87, adjusting controls to drive the vehicle towards the desired position.

If the actual position is on or outside the inner watch circle and if the actual position is on or outside the outer watch circle, then the software shuts drift off 85 and navigates, adjusting controls to drive the vehicle towards the desired position. This method keeps the vehicle from constantly wandering about the commanded position. This method also returns the vehicle to the inner circle at the maximum achievable velocity (minimum time).

This approach supports completely autonomous station keeping as compared with methods that require some operator intervention once the vehicle has reached the desired station. That is, this method is robust to the open ocean environment, and, with appropriate adjustments to inner and outer circles, provides a reliable method for autonomously maintaining station against winds and currents. This approach also supports relatively efficient station keeping as compared with methods that continuously drive towards the desired point and overshoot. By shutting down propulsion and steering, the algorithm conserves energy rather than expending it on circling back towards the desired point.

In another embodiment, during the return to the inner watch circle the software adjusts velocity with a critically damped feedback loop and the error between the actual and commanded position. This balances performance between minimum expended energy and minimum time to recover the inner watch circle.

This embodiment offers all of the advantages of the preferred embodiment with additional energy savings at the cost of time required to recover the station. This embodiment conserves additional energy by slowing propulsion and steering as the vehicle approaches the inner circle rather than maintaining a high thrust rate right up to the boundary. This approach works well for small inner radius circles.

In another embodiment, the software monitors limits the vehicle speed to a small fraction of that required to overcome drift. This method minimizes expended energy.

This embodiment offers all of the advantages of the preferred embodiment with additional energy savings at the cost of time required to recover the station. This embodiment conserves energy by slowing propulsion and steering during the whole transit back to the inner circle rather than maintaining maximum thrust. This approach works well for small inner and outer radius circles and for circumstances where time on station is strongly desired/required.

In another embodiment the software uses several watch circles instead of only two. On exiting the innermost outer circle, a minimum energy policy is applied to recover the station. On exiting the next outer circle, thrust is applied with a critically damped feedback loop as discussed above. On exiting the next outer circle, maximum thrust is applied.

This embodiment offers automatically robust station keeping against changing environmental conditions. If a sudden change of conditions (wind or current) overcomes the vehicle minimum energy drive to recover the inner circle and drives it out of the second outer circle, then a more aggressive algorithm is activated. If conditions overcome this algorithm, then all of the restraints on velocity are removed and the vehicle makes best speed towards the inner circle. Under benign conditions, the vehicle maximizes endurance while maintaining station keeping with tight tolerances. Under more adverse conditions, the vehicle maintains station keeping with lower tolerances and with perhaps some penalty to endurance. The larger watch circles help offset the increase in power consumption.

In another embodiment, the watch circles are operator selected parameters.

This embodiment supports operator programmed station keeping tolerances. It allows the operator to adjust for changing environmental conditions as compared with fix watch circles. It also allows the operator to adjust for operational changes; that is, the operator may be directed to change the station keeping tolerances to support an adjustment in the operational application of the vehicle. Finally, it also allows the operator to adjust the power expended to extend time on station by enlarging the watch circles.

In another embodiment, the watch circles and/or the maximum speed are adjusted by the software to achieve a commanded endurance time on station. The software measures and/or estimates the power flow from the batteries and adjusts station keeping method and parameters based on estimated and/or measured remaining battery capacity.

This embodiment enjoys all the advantages of the other embodiments with the additional advantage that it does not require operator intervention. The vehicle software automatically optimizes for endurance over station keeping tolerances and the time required to recover the station.

4.3.4. Combined Constant Heading and Station Keeping Method

In the preferred embodiment, software running on an on-board processor controlling the vehicle receives a command to maintain a constant heading and a constant position. The software evaluates actual position and heading data, maintaining a state vector of position, heading and speed. In the preferred embodiment, position and heading data are collected by the software from an on-board electronic compass and an on-board Global Positioning System (GPS) receiver. The software operates a simple feedback loop, periodically adjusting propulsion and steering controls based on the error between the actual and commanded position, the actual and commanded heading, and the estimated and desired velocity vector of the vehicle. The software controls steering and propulsion by sending thrust commands to an on-board motor controller that feeds power from the batteries to each thruster motor per the commanded thrust.

In the preferred embodiment, the software gracefully and automatically balances between maintaining constant heading and station keeping. If the error in heading is larger than the error in position, the propulsion and steering commands are dominated by heading commands. If the error in position is larger than the error in heading, the propulsion and steering commands are dominated by position commands (a scaling factor is used to make the errors comparable). Initially, the error term for one command, say the heading, may be much larger than that for position. After computing corrective commands for both position and heading, the algorithm weights each of the commands by the error term associated (heading or position) and combines them. The combined correction command is then weighted towards the command with the larger error. As the command produces a change in the vehicle heading or position, the error term associated with the other command begins to dominate the combined command. The software captures current position and heading at a rate much faster than the vehicle can change either measure, thus avoiding sudden changes in the observed error terms. This causes the algorithm to switch smoothly between constant heading and station keeping methods as one error or the other begins to dominate.

This embodiment operates automatically as compared with methods that require operator intervention to switch between position and heading algorithms. The algorithm also operates more robustly than methods that schedule one method, then the other, and more robustly than methods that apply fixed weights to heading and position commands.

4.3.5. Propulsion and Navigation Control

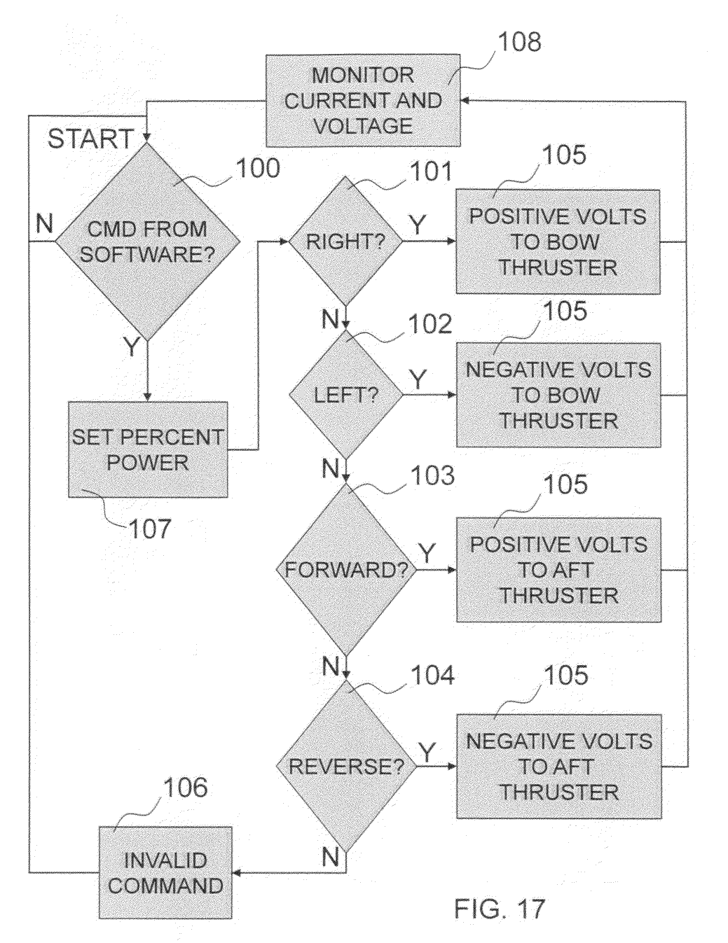

In each of the three algorithms described above, software commands steering and propulsion. In the preferred embodiment, software executes these commands through a motor controller, as shown in FIG. 17, that accepts two dimensional commands from software 100, for example RIGHT 101, LEFT 102, FORWARD 103, REVERSE 104. The motor controller simultaneously controls two motors 105 based on these commands or discards the command as invalid 106. The bow thruster implements RIGHT 101 and LEFT 102 by providing thrust orthogonal to the body towards the forward end. The aft thruster implements FORWARD 103 and REVERSE 104 by providing thrust along the body axis. The motor controller also accepts a percent power parameter 107 for each of the two dimensional commands to modify the turning rate or forward/reverse rate. Slower forward speeds require reduced orthogonal thrust to achieve the same turn rate. Similarly, forward thrust may be reduced during turning to slow the vehicle to affect a more rapid turn. Using the two dimensional commands and the power parameter, the motor controller controls the transfer of power from the batteries to the motors to execute the commands. While applying power, the motor controller monitors the current and voltage at the interface 108 with the motor, verifying that the motor consumes power as expected. A motor controller with these interfaces and functions is commonly referred to as an intelligent motor controller.

In another embodiment, the software also commands the motor controller to operate the motors in either a differential thrust configuration or a bow thruster/aft thruster configuration.

The use of an intelligent motor controller greatly simplifies the design and manufacturing as compared with implementing discrete relay or solid state power control. The use of an intelligent motor controller also reduces the computing requirements for the vehicle controller software as compared with an approach where the software controls the flow of power directly.

4.3.6. General Navigation and Mission Control

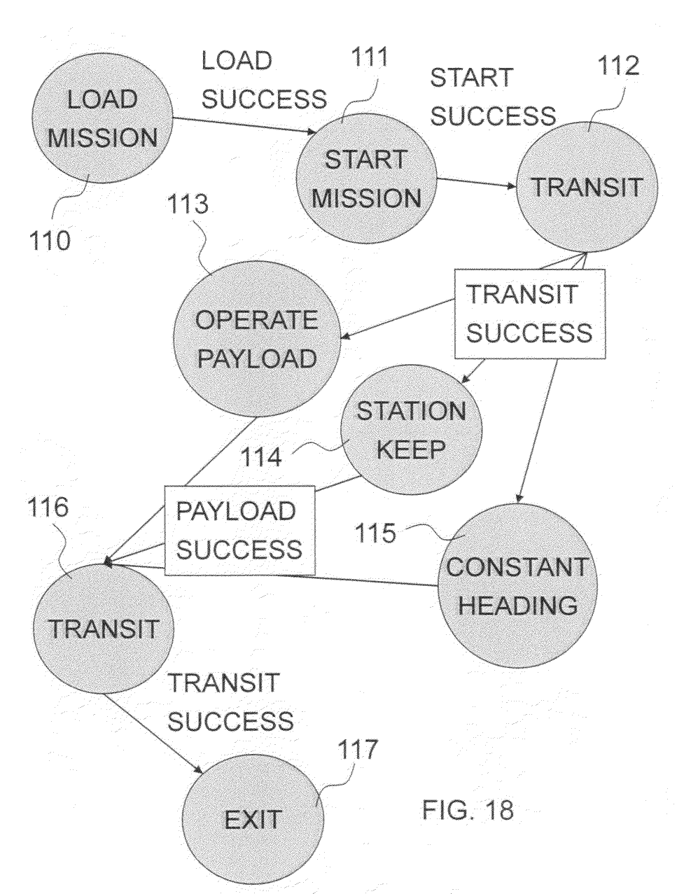

In the preferred embodiment, additional software functions operates an event-based sequence (a mission) by monitoring for event conditions and operating the transit, station keeping and constant heading methods in sequence as shown in FIG. 18. The software accepts a set of commands and parameters, referred to as a mission file. The mission file consists of commands including: transit, station keep, maintain constant heading and operate payloads. The commands include associated parameters, such as time on station or the heading to maintain. The mission file also includes parameterized events that trigger the execution of particular commands. These parameterized events affect the desired vehicle behavior when executed by the software. FIG. 18 illustrates a mission with transit, station keeping, constant heading, payload operations, another transit and completion. The software first attempts to load the mission 110. On successful load, defined as accepting a complete set of correctly formatted input data, the software starts the mission 111. Given a successful start event, defined as the occurrence of a specific set of conditions specified in the mission file, the software then commands the transit 112 associated with the start event. When the software detects a successful transit (here the conditions for the event may be specified as the vehicle position being within a circle of some diameter about a desired target point), the software then commands several methods associated with the transit success event. It begins payload operations 113, station keeping 114, and maintains constant heading 115. On the payload success event (here the conditions for the event may be specified as the collection of a specific acoustic signature or the collection of data for a specific amount of time), the software ends all three methods and commands a second transit 116. On the transit success event, the software exits the mission 117 and stops all methods.

The mission file may define complex sequences of operations and events, such as complex route sequences, including alternate routes, defined by a series of transit commands and independent events. The mission file may also define complex sequences of station keeping assignments and specific payload operations, again based on independent events. Note that this gives the vehicle functionality beyond a simple ordered list of commands or even a time-based sequence since measurements made during the mission may trigger events, subsequently causing the vehicle to behave in a way that depends on the conditions encountered during the mission.

In one embodiment, the commands are using a text format mission file with one command one each line and a delimiter character separating the commands, options and parameters on a single line.

<example text mission file>
# Mission File
#Waypoint 30.40593611 −97.717165778 216.26
# Lake Georgetown
#Waypoint 30.67992750 −97.74370389 223.67
# Waypoint 30.67992750 −97.74570389 223.67
Waypoint 30.68038 −97.74368 223.67
Instruction collect 234 4125000
Waypoint 30.68060 −97.74336 223.67

This approach simplifies the interface as compared with requiring the operator to enter the commands sequentially, resulting in more efficient mission execution. It also supports consistently repeatable missions, critical to operating a fleet of vehicles in concert, to collecting consistent data and to reliably navigating past hazards.

In the preferred embodiment, the mission file consists of data defined by extensible markup language (XML). An XML schema defines the mission file XML tags and content.

<example XML mission file>
<?xml version=“1.0” encoding=“UTF-8”?>
<!--Sample XML file generated by XMLSPY v5 rel. 2 U
(http://www.xmlspy.com)-->
<mission xmlns=“http://www.j3s.us/ONASMissionSchema”
xmlns:ob=“http://www.j3s.us/ONASBaseSchema”
xmlns:oc=“http://www.j3s.us/ONASCommandSchema”
xmlns:xsi=“http://www.w3.org/2001/XMLSchema-instance”
xsi:schemaLocation=“http://www.j3s.us/ONASMissionSchema
c:/devel31m3/xcast_onas/xml/schema/onas_mission.xsd”>

<ref_points>

<waypoint name=“WAYPOINT-1” desc=“Gulf of Mexico - Corpus

Christi” lat=“27.705” lon=“−96.793” alt=“0” type=“ABSOLUTE”/>

<waypoint name=“WAYPOINT-2” desc=“Lake Georgetown”

lat=“30.677” lon=“−97.736” alt=“0” type=“ABSOLUTE”/>

<waypoint name=“WAYPOINT-3” desc=“Lake Georgetown - dock”

lat=“30.678” lon=“−97.735” alt=“0” type=“ABSOLUTE”/>

</ref_points>
<event name=“HydrophoneDeployed” desc=“Event generated when

hydrophone has been deployed to proper depth - this should enable data
collection to start”/>

<event name=“DataCollectionComplete” desc=“Event generated after

one hour of data collection”/>

<event name=“HydrophoneRetracted” desc=“Event generated when

hydrophone has been retracted - this signals end of this mission”/>

<event name=“HydrophoneMissionComplete” desc=“Event generated

when hydrophone mission has been completed.”/>

<vehicle name=“J3S-ONAV-1” unique_id=“J3S-00001”>

<event_gen_cmd name=“EventCmd1” desc=“We collect hydrophone

data for one hour - generate event to indicate we are done”
condition=“RELATIVE” event_ref=“HydrophoneDeployed” time=“1:00:00.00”
success_event=“DataCollectionComplete”/>

<navigation_cmd name=“GOTO” description=“Go to waypoint 2

for station keeping”>

<oc:events start=“START-EVENT” success=“WAYPOINT-

2_REACHED”/>

<oc:waypoint waypoint_ref=“WAYPOINT-2”/>
<oc:limits inner=“10.0” outer=“25.0”/>

</navigation_cmd>
<navigation_cmd name=“GOTO” description=“Go to waypoint 3

at end of mission”>

<oc:events start=“HydrophoneMissionComplete”

success=“MISSION_STOP”/>

<oc:waypoint waypoint_ref=“WAYPOINT-3”/>
<oc:limits inner=“5.0” outer=“10.0”/>

</navigation_cmd>
<payload name=“windlass” unique_id=“J3SWinch001”>

<config>

<param key=“type” value=“windlass”/>
<param key=“motor.inputMode” value=“1”/>
<param key=“motor.controlMode” value=“2”/>
<param key=“motor.currentLimit” value=“1”/>
<param key=“motor.acceleration” value=“2”/>
<param key=“motor.serial.port”

value=“/dev/tyyUSB0”/>

<param key=“motor.encoder.installed”

value=“true”/>

<param key=“motor.encoder.used” value=“1”/>
<param key=“motor.encoder.limits”

value=“none”/>

<param key=“motor.encoder.ppr” value=“200”/>
<param key=“uprate” value=“20”/>
<param key=“downrate” value=“20”/>
<param key=“cableLength” value=“3.048”/>
<param key=“cableDiameter” value=“.762”/>
<param key=“channel” value=“1”/>
<param key=“spoolDiameter” value=“8.255”/>
<param key=“spoolWidth” value=“18.415”/>
<param key=“scuttle.password” value=“foo”/>

</config>
<payload_cmd name=“Deploy” payload_id=“J3SWinch001”>

<oc:events start=“WAYPOINT-2_REACHED”

success=“HydrophoneDeployed” interrupted=“DeploymentInterrupted”/>

<oc:params path_name=“cmd_params”>

<oc:param key=“TargetDepth”

value=“35.0”/>

<oc:param key=“SteadyRate” value=“50”/>

</oc:params>

</payload_cmd>
<payload_cmd name=“Deploy” payload_id=“J3SWinch001”>

<oc:events start=“DataCollectionComplete”

success=“HydrophoneRetracted” interrupted=“RetractionInterrupted”/>

<oc:params path_name=“cmd_params”>

<oc:param key=“TargetDepth” value=“0.0”/>
<oc:param key=“SteadyRate” value=“80”/>

</oc:params>

</payload_cmd>

</payload>
<payload name=“hydrophone” unique_id=“NUWC-001”>

<config>

<param key=“Channel” value=“17”/>
<param key=“Frequency” value=“12.667”/>

</config>
<payload_cmd name=“Record” payload_id=“NUWC-001”>

<oc:events start=“HydrophoneDeployed”

stop=“DataCollectionComplete” success=“HydrophoneMissionComplete”/>

</payload_cmd>

</payload>

</vehicle>

</mission>

This approach also simplifies the interface as compared with requiring the operator to enter the commands sequentially, resulting in more efficient mission execution. It also supports consistently repeatable missions, critical to collecting consistent data and to reliably navigating past hazards. In addition to these advantages, it uses a standard format, simplifying and standardizing software interfaces. The standard format also includes rules that validate the mission data, reducing the likelihood of a pathological mission file.

In another embodiment, commands may be sent via a web browser to the vehicle software. In this method, the vehicle runs a web server. The web server provides “pages” that include commands for the vehicle software. The commands are submitted to the controller software with the same standard XML format as the mission file.

This approach provides for “manual” control of the vehicle via a web browser. The approach allows finer control of the vehicle as compared with scripted operations with some loss of autonomy. The approach is particularly useful for testing vehicle control functions or making minor additions to an ongoing mission.

In another embodiment, the software is disabled by command and the vehicle is directly controlled by a standard radio remote control in a manner like a radio control (RC) model airplane, boat, or car. This method uses a motor controller with an RC mode and an RC receiver interface. This method also uses an RC receiver. On command, the vehicle software switches the motor controller to RC mode. An operator then controls the vehicle using an RC transmitter. RC commands are received by an RC receiver on board the vehicle. The RC receiver, connected to the motor controller, relays commands to the motor controller, controlling navigation and steering.

This approach is useful for close operations, such as maneuvers through complex structures as well as deployment and recovery operations. It allows for finer control as compared with scripted interaction. This approach may be useful if on-board sensors are monitored by a human operator who maneuvers the vehicle to optimize, for example, video images.

### 4.4. Web-Based Command and Control

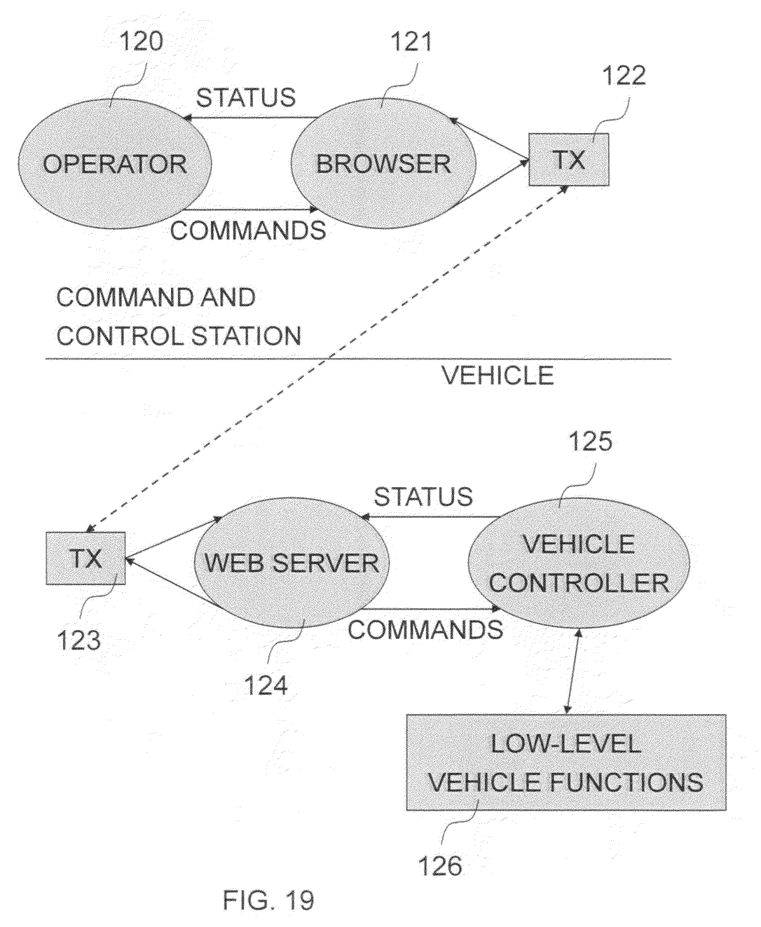

FIG. 19 illustrates the web-based command and control. An operator 120 interacts with a web browser 121 to issue commands and receive information about the mission, payloads and vehicle status. The browser communicates with a web server 124 via a command and control transceiver 122 linked wirelessly with a vehicle transceiver 123. Standard TCP/IP network protocol runs over the wireless link. The web server, running on the vehicle, accepts data for transmission to the browser and passes commands from the browser back to vehicle control software 125 running on the vehicle. The vehicle controller software operates and monitors low level vehicle functions 126 such as propulsion or steering.

4.4.1. Link Between the Vehicle and the Control Station

In one embodiment the vehicle and the command and control station are linked using a standard wireless network, for example IEEE 802.11b (WiFi) or IEEE 802.15 (Bluetooth).

This approach leverages commercially available equipment to develop an open, standard network with low manufacturing costs as compared with custom and/or proprietary network. The design may select from a wide variety of components that meet the industry standard. Having a wide variety of compatible components available reduces the risk to schedule should a particular part become unavailable or delayed. Having a wide variety of compatible components available also reduces the risk to cost as compared with a proprietary communications solution. The approach also reduces frequency allocation issues as compared with approaches that use other frequencies. This reduces the risk that the system will not be allowed to operate in the desired area.

In another embodiment, the vehicle and the command and control station are linked using a proprietary wireless protocol that operates in a standard industrial, scientific and medical (ISM) frequency band.

The approach reduces frequency allocation issues as compared with methods that use other frequencies. This reduces the risk that the system will not be allowed to operate in the desired area. The approach also may offer some specific benefits, such as extended range, that other approaches, including ones that use standard wireless network components, do offer.

In another embodiment, the vehicle and the command and control station are linked using a communications system with a satellite segment, for example by using an Iridium telephone.

This approach offers a much greater range for the command and control station link as compared with approaches that use line of sight radio frequency or power limited range networks. The addition of a satellite segment offers communications over the horizon, supporting global links between vehicles and the command and control station.

In another embodiment, a variety of the above mentioned approaches are used to create links between the vehicle and the command and control station.

This approach supports links appropriate to the mission as compared with fixed link approaches. If the mission deploys the vehicle near by, a standard network protocol may be employed to provide low-cost, high-speed networking between the vehicle and the command and control station. If the mission requires the vehicle to move out of range, a proprietary link may be activated that supports more distant operations. If the vehicle is deployed at some great distance or is moved beyond the horizon, a satellite segment link may be employed to maintain networking. This allows the operator to select the best networking solution for the desired mission.

4.4.2. Command and Control Operations

In the preferred embodiment, an operator loads the mission file, containing commands which specify a sequence of vehicle operations, via the browser interface to the vehicle web server. The operator also starts, suspends and stops the mission (vehicle software) and issues specific commands via the browser interface.

The browser also provides access to status information. This includes current and historical vehicle temperature, battery voltage, heading, position, velocity, thruster commands, mission commands, mission start time, and status of commands issued through the browser.

This approach facilitates development and deployment given the availability of web browsers and web servers. These software products are relatively inexpensive compared with custom client server applications. Web servers and browsers use standard TCP/IP communications protocol, further reducing cost and complexity as compared with custom client server applications. Web servers and browsers, given widespread use, are very robust. Their widespread use has already reduced the number of errors in the software code, particularly as compared with custom client server applications. Web servers and browsers are also robust in terms of users; generally most users are already familiar with the concepts and controls associated with web browsers and require less training as compared with custom client server applications. Users are also less likely to attempt pathological operations with the interface. Web servers and browsers are also more robust in terms of network failures as compared with custom client server applications.

This approach also facilitates expanded developments. Given that the approach uses standard network and communications protocols, additional applications may be developed which replace the browser and operator with automatic control applications.

As an alternative, applications may be developed that operate in concert with a browser, leveraging the standard network and communications protocol to add automatic remote functionality to the vehicle.

This approach also reduces the cost of software maintenance as adding or altering the vehicle “web page” is simpler and generally cheaper than altering custom client server software interfaces.

In another embodiment, the browser interface is expanded to include interfaces to streaming payload data and data snapshots from the vehicle. This includes pitch, roll and yaw, detailed GPS data, and payload data, such as imagery.

This approach provides more detailed information than a standard interface. This additional information supports complex and/or stressful missions, monitoring during bad weather, experimental payloads, real time payloads (for example, ones where the value of the data decrease quickly with time) and vehicle testing.

### 4.5. Submerged Winch for Deploying Electronics Payloads

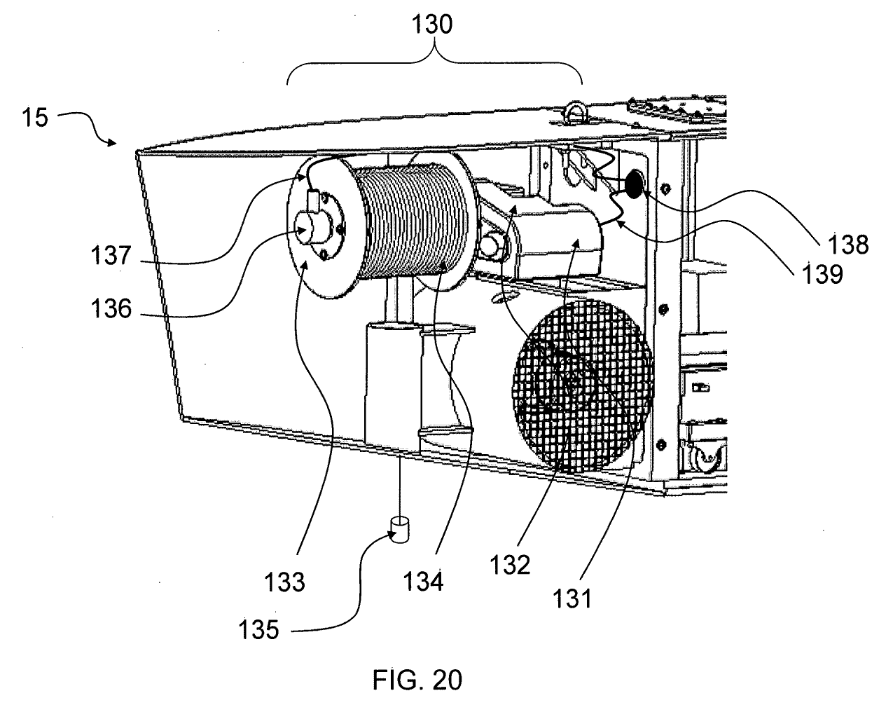

In the preferred embodiment, electronic payloads are deployed from the vehicle via a winch assembly 130 mounted in the free-flood nose fairing 15 as illustrated in FIG. 20. The winch is a motorized assembly that includes a sealed motor 131, transmission 132 and rotating axle. The rotating axle fits inside a spool 133 or drum of electronics cable 134; when the winch is activated, the drum rotates. One end of the electronics cable is attached to the electronics payload 135, for example a hydrophone and pre-amplifier. The other end of the cable is connected to the rotating part of a slip ring inside of the drum. The slip ring transfers electrical connections from the vehicle to the electronic payload through a rotating interface to a stationary part of the slip ring 136. The rotating part of the slip ring connects to the electronics cable on the drum. The stationary part of the slip ring connects to a separate cable 137 which connects to a water tight connector 138 in the forward sealed section bulkhead. Inside the sealed center section, a cable connects the water tight connector to signal acquisition equipment controlled by vehicle software.

Another cable 139 makes a sealed connection to the winch motor terminals. This cable connects the motor terminals to a water tight connector 138 in the forward sealed section bulkhead. Inside the sealed section, a cable connects the water tight connector to a motor controller commanded by vehicle software.

The winch operates autonomously; that is, the vehicle software includes functions to operate the winch, stimulated by commands in the mission file or by direct command from the command and control interface.

The software commands the winch to unwind or rewind specific lengths of cable. In the preferred embodiment, this is implemented using an optical encoder mounted on the winch axle. The optical encoder is connected (via cable and water tight connector or seal) to the motor controller supplying power to the winch. The motor controller includes a feedback interface for the optical encoder, and accepts related commands from vehicle software to operate the winch motor with optical encoder feedback. The commands specify a specific length; the motor controller operates the winch motor until the commanded cable length has been achieved as measured using the optical encoder.

The winch stops automatically when the cable has been fully deployed or rewound. In the preferred embodiment, the cable is routed past a Hall-effect switch. The switch is cabled (via cable and water tight connector or seal) to the motor controller supplying power to the winch. The motor controller includes a feedback interface for the limit switch, and accepts related commands from vehicle software to operate the winch motor with limit switches. The cable has magnets embedded at either end that trigger the Hall-effect switch. When the switch is activated, the motor controller shuts down the motor and notifies the software that a cable limit has been reached.

This approach protects deployed electronics better than an approach that uses a statically (permanently) deployed the cable. With the cable spooled up and the payload safely retracted into the nose fairing, there is less likelihood that normal operations (deployment, recovery, etc.) will damage the payload and/or the cable. Spooled cable is also simpler to deploy (less risk of a tangled mess on the deck) as compared with a statically deployed cable. This approach is more reliable than a passive deployment (spring loaded or released). Again, this approach also reduces the risk of tangling or damaging the payload and/or cable during recovery.

This approach also supports the deployment of the payload to variable depths, something not possible with a statically deployed or passively deployed cable. This supports varied depths desired/required for the payload as well as adjustments for bottom depth and/or hazards in the water.

In another embodiment, the cable is fed through a roller attached to the optical encoder.

This approach measures the cable more directly, providing a clearer measure of the length of cable as compared with measuring spool axle rotations. This comes at the expense of extra parts and some increased risk of fouling.

In the preferred embodiment, the winch assembly (winch, drum, slip ring and cables) is submersible; that is, it operates normally while immersed indefinitely under 1 m of seawater.

This approach allows the vehicle to maintain a smooth line and a lower center of gravity as compared with mounting the winch assembly above the water line. It also simplifies the design and manufacturing significantly as compared with a design that places the winch inside the sealed center section.

### 4.6. Payloads

In the preferred embodiment, the vehicle may carry a large variety and number of payloads. Payloads may include optical sensors (light intensity, light detection and ranging (LIDAR), cameras, video, hyperspectral imagers) above water and below water, acoustic sensors (passive hydrophones, active transducers, side scan sonar, depth finder, underwater communications), magnetic sensors, gravity sensors, underwater environmental sensors (conductivity/temperature/depth (CTD), photosynthetically active radiation (PAR), dissolved oxygen (DO), pH, turbidity, fluorescence, current, sound speed), above water environmental sensors (air temperature, pressure, humidity, wind velocity, wave height, Light Detection and Ranging (LIDAR), radar, RF communications, communications relays, or an anchor.

In one embodiment, the vehicle software is based on a modular architecture that segments payload functions from the main vehicle controller. The payload modules are based on a template that embodies a well-defined interface to the vehicle controller software. For each payload, a module is written that implements payload functions in compliance with the well-defined interface to the vehicle software. The interface includes configure, start, update, stop and reset commands. The payload module implements these commands in the payload module with the particular low-level functions required for a given payload. For example, an analog-to-digital conversion (ADC) card module may be configured to acquire data from a particular channel at a particular rate. The start command may initiate acquisition and start data spooling to a file. The update command may not do anything. The stop command may stop acquisition and the reset command release buffers and reset the ADC card. All of these commands would be implemented in the ADC module using commands and data particular to the ADC card itself.

In addition to the vehicle software architecture, other design elements accommodate a large variety and number of payloads. The removable electronics tray accommodates various configurations of electronic components. Access fore and aft through the bulkheads and topside via the access ports also accommodate a variety of payloads. In addition, the enclosed wet space in the nose fairing and aft fairing provide protected access to the water. These features combine to uniquely support a large variety and number of payloads with the potential for components internal and external to the hull.

The approach supports a large variety and number of payloads without incurring significant cost for re-design and re-implementation of the basic vehicle. The addition or alteration of payloads has little impact on the physical arrangement of the vehicle as compared with systems designed around the payload. Similarly, payload software alterations are limited to the payload modules, limiting the number of changes and the amount of regression testing as compared with monolithic systems built around a particular set of payloads. Finally, the modular nature of the software and flexible hardware accommodate changes in payloads. For example, additional features or a form-fit-and-function replacement are relatively easily accommodated as compared with monolithic, single purpose systems.

In the preferred embodiment, the module implements a standard interface for executing commands. The commands are embedded in the mission file or sent via the web interface and are passed directly to the module via this standard interface. The module then executes the commands on the payload.

This approach enjoys all of the advantages of the previously mentioned embodiment with the significant addition of configurable commanding. Commands appropriate to the payload are implemented into the software rather than a strictly limited set of commands. The mission file may be configured to take advantage of these commands as a parameter, offering significantly more capable and flexible mission configuration as compared with missions that are limited to a strict set of commands.

### 4.7. References

The following references are incorporated herein as though restated in full:
1. Brooks, R. A., “A Robust Layered Control System for a Mobile Robot,” IEEE Journal of Robotics and Automation, RA-2, p. 14-23, 1986.
2. Brooks, R. A., “A Robot that Walks: Emergent Behavior from a Carefully Evolved Network,” Neural Computation, 1(2), p. 253-262, 1989.

What is claimed is:

1. An autonomous water surface vehicle comprising:
a non-planing segmented hull comprising a water-tight tubular center section of vertically and horizontally symmetrical rectangular cross-section, a forward bulkhead permanently attached to a front end of the center section, an aft bulkhead attached and sealed to an aft end of the center section by fasteners and a gasket; a free-flood forward fairing fastened to the center section at the forward bulkhead, and a free-flood aft fairing fastened to the center section at the aft bulkhead;
at least one fixed steering thruster, mounted to the forward bulkhead, enclosed by the free-flood fore section, and positioned and arranged to provide steering thrust laterally relative to the long axis of the hull such that the thrust pivots the hull about a vertical axis as the only means of heading control;
a fixed axial thruster, mounted to the aft end of the center section and positioned and arranged to provide thrust parallel to the long axis of the hull;
a battery positioned and arranged to provide power to the forward fixed thruster and the aft fixed thruster;
an autonomous navigation system comprising: a position sensor, a heading sensor, a speed sensor, a pitch sensor, a roll sensor, and a computer positioned and arranged to receive input from the position, heading, speed, pitch, and roll sensors and provide output to the fixed turning thruster and fixed axial thruster based on operation of a feedback loop that calculates the error between the inputs and a desired heading, a desired speed, or a desired location; and
an autonomous mission system comprising a computer positioned and arranged to receive electronic signals representing a mission file from a web server and positioned and arranged to provide electronic control signals to a payload and an autonomous navigation system and wherein the mission file comprises desired conditions or actions.

2. The autonomous water-borne vehicle of claim 1 further comprising a web-based command and control system comprising: the web server operating aboard the vehicle; a web client station operating at a command and control station and interacting with the web server through a TCP/IP network linking the web server to the client station.

3. The autonomous water-borne vehicle of claim 1 further comprising: a submersible winch mounted to the forward bulkhead entirely within the forward free-flood section of the hull comprising:
an electric motor;
a motor controller in the sealed center section positioned and arranged to receive input signals from the autonomous mission system;
a power cable connecting the electric motor to the motor controller through a water-tight penetration in the forward bulkhead;
a cable drum mechanically connected to the electric motor;
an electronics cable positioned and arranged to be stored on the cable drum and deployed or retrieved by rotation of the cable drum;
a submersible slip ring assembly connecting the electronics cable to a fixed cable connected to the autonomous mission system inside the sealed center section through a water-tight penetration in the forward bulkhead; and
a submersible optical encoder mechanically connected to the cable drum and electrically connected to the autonomous mission system.

4. The autonomous water-borne vehicle of claim 1 further comprising:
a removable electronics tray generally congruent with the sealed center section on which the autonomous mission system and the autonomous navigation system are mounted;
wheels mounted on a left edge and a right edge of the removable electronics tray; rails mounted in the sealed center section positioned and arranged to receive, support, and guide the wheels mounted on the removable electronics tray, enabling the removable electronics tray to be loaded and unloaded by removing the aft sealed bulkhead.

5. The autonomous water-borne vehicle of claim 1 further comprising:
a removable electronics tray generally congruent with the sealed center section on which the autonomous mission system and the autonomous navigation system are mounted;
pads mounted on a left edge and a right edge of the removable electronics tray; rails mounted in the sealed center section positioned and arranged to receive, support, and guide the pads mounted on the removable electronics tray, enabling the removable electronics tray to be loaded and unloaded by removing the aft sealed bulkhead.

6. The autonomous water-borne vehicle of claim 1 further comprising:
a removable battery tray generally congruent with the sealed center section on which the battery is mounted;
wheels mounted on a left edge and a right edge of the removable battery tray; rails mounted in the sealed center section positioned and arranged to receive, support, and guide the wheels mounted on the removable battery tray, enabling the removable battery tray to be loaded and unloaded by removing the aft sealed bulkhead.

7. The autonomous water-borne vehicle of claim 6 further comprising:
a pitch trim adjustment jack screw positioned and arranged to adjust the relative longitudinal position of the battery tray within the sealed center section; and
a roll trim adjustment jack screw positioned and arranged to adjust the relative lateral position of the battery tray within the sealed center section.

8. The autonomous water-borne vehicle of claim 1 wherein the sealed center section comprises a tube formed by folding and welding sheets of plastic.

9. The autonomous water-borne vehicle of claim 1 wherein the forward and aft sections are constructed by folding and welding sheets of plastic.

10. The autonomous water-borne vehicle of claim 1 wherein the sealed center section comprises a tube formed by folding and welding sheets of metal.

11. The autonomous water-borne vehicle of claim 1 wherein the forward and aft sections are constructed by folding and welding sheets of metal.
